(19) United States
(12) Patent Application Publication
(10) Pub. No.: US 2025/0003152 A1
(43) Pub. Date: Jan. 2, 2025

(54) CITRIC ACID-CATALYSED CURRAN MODIFIED CARD BOARD MATERIALS

(71) Applicants: CELLUCOMP LIMITED, Burntisland Fife (GB); TEKNOLOGISK INSTITUT, Taastrup (DK)

(72) Inventors: Eric Arron WHALE, Edinburgh (GB); David Gwyddon HEPWORTH, Edinburgh (GB); Kenneth KISBYE, Holbæk (DK); Alexander BARDENSHTEIN, Hedehusene (DK)

(73) Assignees: CELLUCOMP LIMITED, Burntisland Fife (GB); TEKNOLOGISK INSTITUT, Taastrup (DK)

(21) Appl. No.: 18/706,152

(22) PCT Filed: Nov. 2, 2022
(86) PCT No.: PCT/EP2022/080516

§ 371 Date: Apr. 30, 2024

(30) Foreign Application Priority Data
Nov. 2, 2021 (GB) 2115744.1

(51) Int. Cl. D21H 11/12; B65D 65/42; C09D 7/65; C09D 103/02; C09D 129/04; C09D 133/04; D21H 11/04; D21H 17/28; D21H 17/36; D21H 21/16; D21H 21/20; D21H 23/04; D21H 27/10; D21J 1/08; D21J 3/10; D21J 3/12

(52) U.S. Cl. CPC D21H 11/12; B65D 65/42; C09D 7/65; C09D 103/02; C09D 129/04; C09D 133/04; D21H 11/04; D21H 17/28; D21H 17/36; D21H 21/16; D21H 21/20; D21H 23/04; D21H 27/10; D21J 1/08; D21J 3/10; D21J 3/12

(57) ABSTRACT

The present invention relates to preparing a biodegradable and reusable cellulose comprising cellulose fibres and material from other plant fibres. The invention also relates to a material obtainable from such a process and the use of such a material to improve the properties of articles comprising such material.

### TECHNICAL FIELD

The present invention relates to a process for preparing a biodegradable and reusable cellulose comprising cellulose fibres and material from parenchymal plant fibres. The materials are useful for a wide variety of applications, such as disposable and/or recyclable food packaging and/or drink packaging.

### BACKGROUND TO THE INVENTION

The present invention relates generally to the field of biodegradable materials comprising cellulosic fibres, more specifically to packaging material comprising cross-linked cellulosic fibres with inherently high strength.

WO 2011/003565 A2 and WO 2012/093036 A2 both relates to non-foil packaging laminate for liquid food packaging comprising a layer of paper or other cellulose-comprising material with an outermost liquid-tight barrier layer or polyolefin-based polymers and a metallic layer deposited by chemical vapour deposition (CVD) on the inner side of the layer of paper or cellulose-based material. The CVD-deposited material may be a layer consisting predominantly of aluminium. The packaging necessarily comprises a metal layer.

US 2001/0005550 A1 relates to a method of producing a laminated packaging material comprising a core layer of paper or paperboard and a barrier layer applied on one side of the core layer, wherein an aqueous polymer dispersion or polymer solution is applied as a barrier layer on at least one side of a carrier layer and is dried during heating for driving off water, whereafter the carrier layer with the applied, dried barrier layer is combined and permanently united with one side of the core layer. A layer of polyvinyl alcohol is described as possessing superior strength properties as compared to a layer of aluminium.

US 2001/0005550 A1 discloses a method of producing a laminated packaging material including a core layer of paper or paperboard and a barrier layer applied on one side of the core layer and a laminated packaging material produced accordingly. Preferably, starch or a starch derivative is used as a barrier layer. The laminate however is multi-layered with thermoplastic outer layers.

Packaging materials including several layers of polyolefins and aluminium foil are hard to re-pulp (recycle) due to problems in separating the plastic coating from the paper, paperboard and/or carboard. There remains a need for a packaging material that is recyclable, whilst still providing barrier against oxygen and moisture. Such a packaging material is preferably heat-sealable.

U.S. Pat. No. 5,190,563 describes a method of intra-molecularly cross-linking wood pulp cellulosic fibres, that is linking cellulosic fibres to themselves, using polycarboxylic acids, such as citric acid. Such fibres are described as possessing improved responsiveness to wetting compared to conventional, uncross-linked fibres.

In conclusion, with regard to the above descriptions of the art, it is apparent that there is a need for a packaging material that has improved strength, can be modified or shaped easily, is non-leaching upon use, and that allows complete biodegradation at the end of life due to entirely sustainable components.

### BRIEF DESCRIPTION OF THE DRAWINGS

Embodiments of the invention are further described hereinafter with reference to the accompanying drawings, in which:

FIG. 1 is a stress-strain measurement of material prepared according to the first aspect of the invention [Example 6] (top) and a comparative material prepared without parenchymal plant material in the form of microparticles [Example 3] (bottom)].

FIG. 2 depicts a yogurt pot manufactured from material according to the invention. The yogurt pot has treated with a thin coating (ca. 10 μm) of a polymer and parenchymal microparticulate plant material to provide a water barrier layer (ca. 0.4-0.6 g per pot). The pots are fully biodegradable and are comprised of 95-96 wt. % cellulose.

FIG. 3 depicts a yogurt pot manufactured from material according to the invention after 30 days of storing yogurt (above: filled with yogurt, below: emptied of yogurt). The photograph demonstrates that the material according to the invention is suitable for use as food packaging.

FIG. 4 depicts (a) a moulded article prepared from normal bleached kraft pulp and (b) a moulded article prepared under identical conditions formed from cross-linked material according to the invention. The moulded article prepared from normal bleached kraft pulp exhibits “fibre lift-up”, which is where the fibres extend from the surface of the moulded article. The moulded article prepared from cross-linked material according to the invention do not exhibit “fibre lift-up”, and allow better barrier layer formation and thinner barrier layer formation.

FIG. 5 depicts the results of simulating paper repulping. FIG. 5(a) depicts the result of 50 minutes of simulated repulping of a commercially available orange juice carton with a conventional plastic barrier layer. It is clear to see that the plastic barrier layer is almost entirely intact as a continuous plastic sheet. FIG. 5(b) depicts the result of 50 minutes of simulated repulping of an article according to the invention coated with an acrylic comprising barrier layer. It is clear to see that a homogeneous suspension has been formed and no continuous plastic sheet elements can be seen.

FIG. 6 is bar graph of the average wear index on the y axis (mg/1000 revolutions) of the of paper derived from various pulp compositions (along y-axis).

FIG. 7 depicts biodegradability (Y-axis, in %) against time (X-axis, in days). The top line (circles) is result of the sodium benzoate reference compound. The next top line (trapezoids) is the result of Example 19A.

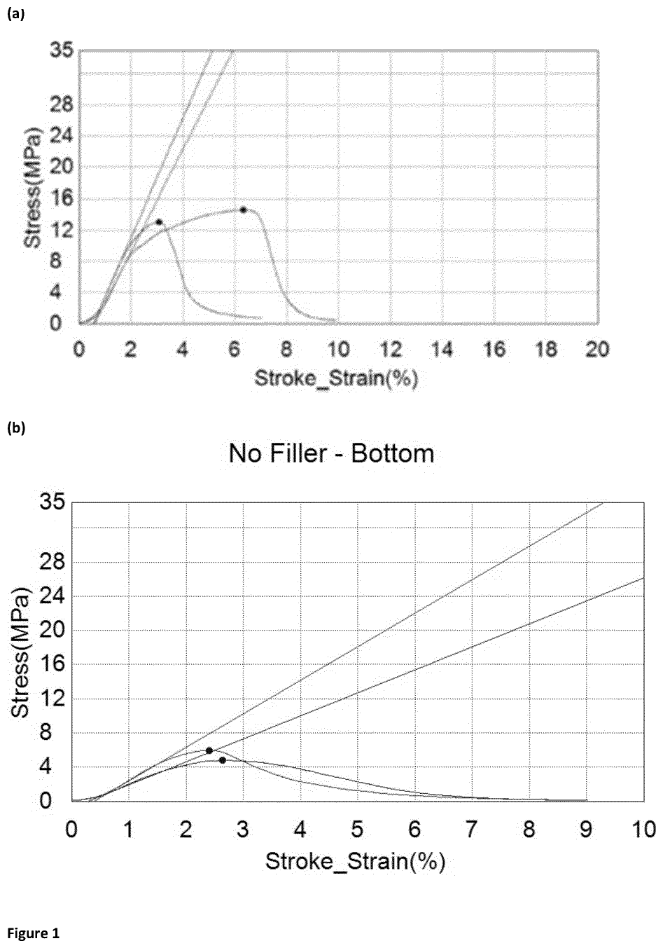

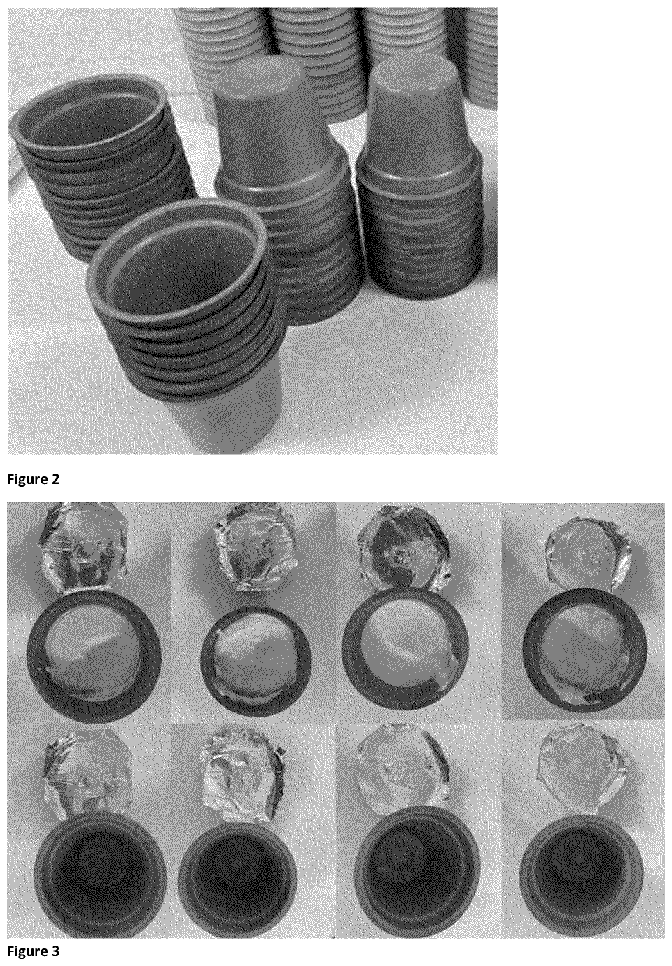

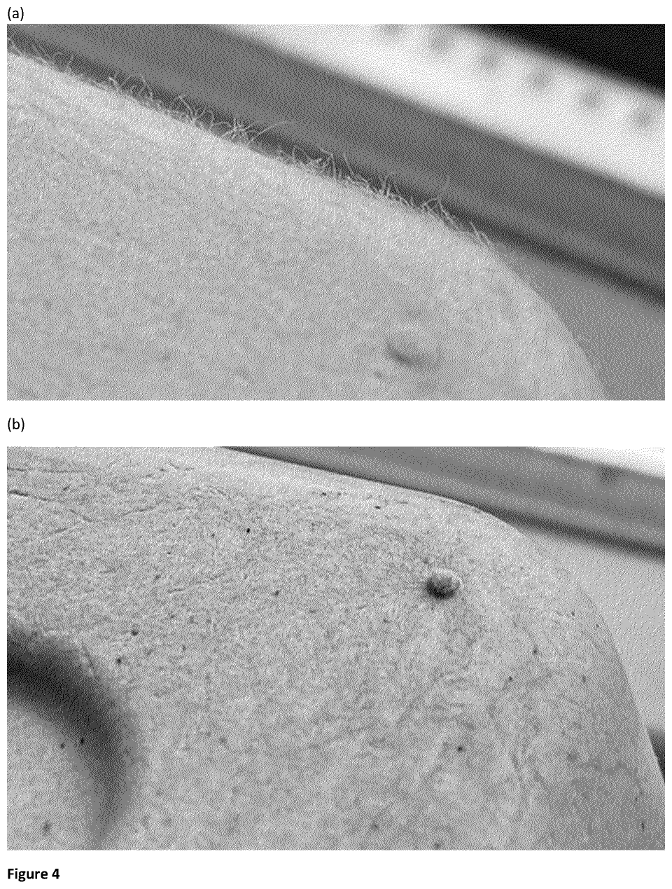

### SUMMARY OF THE INVENTION

In a first aspect, the present invention provides a process for obtaining a paper material having a high wetted conformal stability, the process comprising the steps of:
a) providing a cellulose-containing parenchymal microparticulate plant material, preferably comprising microparticles having an average particle diameter of from 10 μm to 500 μm as determined by ISO method NO. 20998-3:2017;
b) suspending the cellulose-containing parenchymal plant material in a solution, preferably an aqueous solution;
c) mixing the suspension of cellulose-containing parenchymal microparticulate plant material with a suspension of a wood pulp, preferably an aqueous suspension of a kraft pulp;
d) providing one or more linker compounds and one or more esterification catalysts to the mixed suspension, wherein each of the one or more linker compounds comprise two or more carboxylic acid moieties, under conditions that allow the mixture to react at least in part;
e) isolating the solids from the suspension;
optionally, f) drying the isolated solids or the shaped article.

Surprisingly, the present process finds several unexpected advantages despite commencing with particles of plant material of a size broadly equivalent to that obtained in prior art processes which homogenise plant material in water to form a slurry. The advantages noted include a comparatively lower viscosity for the present slurry obtained in step (b) as compared to traditional wood-based cellulose, which allows improved processing at a higher solids content relative to prior art processes in steps (c) and (e) of the process, yielding a more efficient process overall. This comparatively lower viscosity also allows for improved quality materials obtainable by wet moulding. Also, it has surprisingly been found that forming the plant material into the particles without complete degradation of the cell wall enables the material to cross-link to form a material with improved strength, that can be readily dried and used for biodegradable packaging.

In a second aspect, the present invention provides cellulose-containing material obtainable by the process of the present invention, comprising cross-linked material derived from parenchymal plant material, optionally microparticles having an average particle diameter of from 10 μm to 500 μm. These materials surprisingly have a strength twice as high as comparable cross-linked material comprising no parenchymal plant material. This advantageously allows for lighter packaging using biodegradable materials.

### DETAILED DESCRIPTION OF THE INVENTION

The process of the present invention is now described in further detail. Optionally, the process of the present invention can be carried out as a continuous process, rather than being conducted batch-wise. This has significant advantages in terms of the efficiency of the process. The low comparative viscosity of the mixture formed in the present invention enables continuous processing to be conducted without difficulty, especially for processes involving wet moulding.

As used herein, “a,” “an,” “the,” “at least one,” and “one or more” are used interchangeably. Also, herein, the recitations of numerical ranges by endpoints include all numbers subsumed within that range. The terms “comprises” and variations thereof do not have a limiting meaning where these terms appear in the description and claims. The words “preferred” and “preferably”, advantageous refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Plant Material: The starting material for the materials according to the present invention comprises herbaceous plant material. The term “herbaceous” as defined herein refers to plants which are annual, biennial or perennial vascular plants. In annual, biennial or perennial vascular plants, the stem matter dies after each season of growth when the plant becomes dormant, i.e. biennial or perennial plants, or dies, i.e. annual plants. Biennial or perennial plants survive unfavourable conditions underground and will regrow in more favourable conditions from such underground portions of the plant, typically stem, roots, or storage organs such as tubers. In contrast, the stems of woody species remain during any period of dormancy, and in a period of further growth will form growth rings which expand the girth of existing tissue. Herbaceous plants are characterised by parenchymal tissue having an abundance of primary cell walls within the tissue. One skilled in the art would also be aware that the mosses and macro algae also consist of an abundance of primary cell walls, and hence are included within the term “herbaceous plant material” as used herein. Herbaceous plant material is preferably used as a starting material within the present invention. Optionally, the starting material of the present invention substantially consists of herbaceous plant material. It can be advantageous for the starting material of the present invention to consist of herbaceous plant material, and thereby exclude wood or wood products. Depending upon the intended end use of the cellulose-containing material, however, it may not, however, be necessary to totally avoid inclusion of non-herbaceous plant material such as wood within the plant starting material.

In particular, the plant material used in the process of the present invention can conveniently include vegetables, for example root vegetables, and fruit. Non-limiting examples of suitable root vegetables include carrot, sugar beet, also commonly referenced as “beet”, turnip, parsnip and swede. Exemplary fruit materials which can be used within the present invention includes apples, pears, citrus and grapes. Optionally, the plant material may be from tubers, for example potato; sweet potato, yam, rutabaga and yucca root can also be used.

Preferably, the process is one wherein the parenchymal microparticulate plant material is composed of treated herbaceous plant material selected from root vegetables including carrot, sugar beet, turnip, parsnip and swede; fruit materials including apples, pears, citrus and grapes; and/or tubers, including potato; sweet potato, yam, rutabaga and yucca root; preferably sugar beet.

Generally, it is anticipated that the process of the invention will be operated using waste or coproducts from the plant material after a main product has been extracted, for example sugarbeet pellets, vegetable peelings or citrus waste after juicing, jam-making or the like. However, this is not strictly necessary, and the process could be operated using vegetable or fruit grown specifically for that purpose. It is also not necessary for the plant material to be used as a starting material in the process of the present invention to comprise material from only one specific plant source.

Optionally, a mixture of materials from different plant sources can be used. For example, the starting material can comprise a mixture of different root vegetables, a mixture of different fruits, a combination of fruit and vegetable(s), including a mixture of root vegetables together with a mixture of fruits.

Generally, the plant material to be used as a starting material for the present invention will not comprise a significant quantity of lignin. Optionally, the starting material for the present invention will comprise less than about 20 wt. % lignin, for example less than about 10 wt. % lignin, for example less than about 5 wt. % lignin, for example less than 2 wt. % lignin, for example less than about 1 wt. % lignin. A number of methods for the measurement of lignin content are known in the art and include methods such as the “Klason method”, the acetyl bromide method and the thioglycolic acid method. Hatfield and Fukushima (Crop Sci. 45:832-839, 2005) discuss methods of lignin measurement.

The plant material preferably comprises chemically untreated raw plant material, i.e. uncooked. Alternatively, it may have been subjected to an extraction step to remove water soluble compounds, reducing or eliminating the need for an additional washing treatment.

A particularly preferred starting herbaceous plant material comprises sugar beet (beta vulgaris) materials obtained after the sugar juice extraction step. Other suitable materials may be passed through a similar process, e.g. orange peels or apple residue obtained from pressing of juice. Ideally, in this process, the raw plant materials are washed to remove any non-plant material debris or contaminants and leaves. Then typically juice is obtained from those plant materials, by washing and cut up into chips having a thickness in the range of from 0.2 to 0.5 cm. In case of sugar beets, sugar is extracted from these chips typically by contacting the chips with hot extraction water, usually in a counter-current direction in an extraction tower. The crude extract is then usually filtered off, and further worked up. The remaining chips were found to form a particularly good starting material for the present process. In the production of sugar, sugar beets are harvested, washed and processed in sugar beet cutting machines to form chips. The beet chips are subsequently extracted with hot water, at a temperature ranging of from 65° C. to 75° C., generally in a counter-current flow direction, and primarily using a diffusion process, and eventually a physical separation, such as pressing and/or centrifugation. This results in extracted sugar beet chips and sugar-containing raw sugar beet juice. These extracted sugar beet chips primarily comprise of the cell wall and fibre constituents of the extracted sugar beet. In a subsequent processing stage, the beet chips are typically further dewatered by pressing them in so-called pulp presses, which results in pressed chips and released press water, optionally also using pressing aids. These dewatered and pressed chips are then typically subjected to a thermal removal of the residual water. Herein, the pressed chips are dried at an elevated temperature in rotating and heated drying drums, evaporating residual water and constituents volatile at the conditions. Conventional drying systems apply a so-called high-temperature drying, whereas alternative drying methods make use of indirect drying by means of superheated steam using a fluidized-bed method. Sugar-containing molasses are typically added at this stage if the pressed chips are to be employed as animal feed component. The pressed and dried chips are then usually pelletized, by simultaneously pressing the chips to obtain a compressed composition, and by passing the compressed composition through a granulator such as an extruder or hammer mill, wherein the composition is pelletized. The thus obtained pellets are usually added to animal feedstuff, typically those enriched with sugar-containing molasses, but are converted in the present process to parenchymal microparticulate material.

The plant material may also be treated prior to, or after optionally comminuting to a smaller particle size. Alternatively, the obtained microparticulate matter may be treated. Accordingly, the material may be subjected to a process involving contacting the plant material or obtained with a suitable reagent, such as an alkaline reagent, such caustic soda or lye, and/or water, or an aqueous solution of a peroxide, such as hydrogen peroxide, and/or an oxidative treatment, such as e.g. a hypochlorite. It is not essential for the reagent to be added simultaneously with the water. However, it is often convenient to add the water and reagent simultaneously. For example, it is possible to premix the reagent with the water and then to add the water-reagent mixture to the plant material, or microparticles. Alternatively, it is possible to add water to the particles of plant material to form an aqueous slurry, and then to add the reagent to the slurry. Advantageously, addition of the water and/or reagent is accompanied by stirring of the resultant mixture to facilitate formation of a homogenous composition. The volume of water to be added is not particularly critical, but may typically be from 2 litres to 30 litres water per kg plant material particles. This is in addition to any solution of reagent which may additionally be added. One of the benefits of the present invention is the relatively high percentage of solids which can be present within the mixture after the addition of water and reagent. In some embodiments, the mixture formed in step (a) can contain more than 2 wt. % solids. In some embodiments, the mixture formed in step (a) can contain at least 3 wt. % solids, for example at least 4 wt. % solids, at least 5 wt. % solids, at least 6 wt. % solids, at least 7 wt. %, at least 8 wt. % solids, at least 9 wt. % solids, or at least 10 wt. % solids.

This treatment step is intended to essentially to not break down the particles, but to remove components that may dissolve easily. The process may then be followed by a filtration and washing step to remove unused reagent and soluble components, and drying step.

The cellulosic product, whether washed, treated and washed or directly obtained from a process to remove juices or other desired components is then optionally subjected to a comminution step, e.g. by milling the materials, to obtain a microparticulate material.

An optional process for preparing cellulose-containing herbaceous plant material, comprises the steps of:
(i) contacting particles of plant material with a peroxide agent and water;
(ii) allowing the mixture from step (i) to hydrate until the pH of the mixture is pH 4.5 or less; and
(iii) homogenising the mixture from step (ii) and isolating the cellulose containing material,
and wherein the particles of plant material in step (i) have an average particle diameter of from 10 μm to 800 μm.

### Provision of the Cellulose-Containing Herbaceous Plant Material and Process to Obtain the Parenchymal Microparticulate Materials

A preferred process for preparing the cellulose-containing parenchymal microparticulate plant material for use in the process according to the invention, comprises the following steps:
(i) providing a mixture of herbaceous plant material, peroxide reagent and water;
(ii) heating said mixture to a temperature in the range of from 30 to 100° C. and maintaining said mixture at a temperature in the range of from 30 to 100° C. for a period of time in order to break down the plant material; and
(iii) isolating a residue comprising cellulose-containing particles, wherein said process comprises monitoring the pH of the mixture during step (ii) and terminating the maintaining of the mixture at a temperature in the range of from 30 to 100° C. when the mixture reaches a predetermined pH value.

In this process the pH value can be determined from a calibration giving the viscosity in water of the cellulose-containing particles to be expected as a function of pH of the reaction mixture in step (ii).

Thus, one example of the process comprises performing a calibration whereby the process is carried out several times under the same conditions except that the period of time at which the mixture of step (ii) is maintained at a temperature of from 30 to 110° C., for example 30 to 100° C., is varied. Each time the reaction mixture is sampled. The pH is first measured and the sample then separated into an insoluble residue containing the cellulose-containing particles and a reaction liquid component. The viscosity in water of the cellulose-containing particles is measured and a correlation between viscosity of the cellulose-containing particles and pH of reaction mixture of step (ii) can thus be obtained.

No pH-modifying additives need be added to the mixture of step (i) or step (ii) during the process. By pH-modifying is meant adjusts the pH of the mixture by a magnitude of greater than 0.5. The present studies have involved an investigation into the viscosity behaviour of the cellulose-containing particles formed by the process of the invention as a function of the period of time the mixture of step (ii) is held at a temperature of between 30 to 110° C., for example 30 and 100° C. It has been found that the viscosity of the cellulose-containing particles does not vary linearly with time. Unless otherwise specified, as referred to herein, the viscosity of the cellulose-containing particles is the viscosity the particles at a concentration of 1% dry weight in water as measured at 20° C. using a Brookfield viscometer with RV spindles rotated at 10 rpm.

The mixture may be maintained at a temperature of between 30 to 110° C., for example 30 and 100° C., for a predetermined period of time in order to produce particulate cellulose having a desired viscosity. The length of time can be determined by a calibration run carried out under the same conditions. The calibration may change if the concentration of the starting materials (plant material and peroxide reagent), the type of plant material or the temperature at which the reaction mixture is maintained changes.

More preferably, the cellulose containing particles for use in the present composition are prepared by a process comprising:
(i) providing a mixture of plant material, peroxide reagent and water;
(ii) heating said mixture to a temperature in the range of from 30 to 100° C. and maintaining said mixture at a temperature in the range of from 30 to 100° C. a period of time in order to break down the plant material; and
(iii) isolating a residue comprising cellulose-containing particles, wherein said period of time is chosen so as to produce cellulose-containing particles having a desired viscosity in water. In this process said period of time can be determined from a calibration which gives the viscosity in water of the cellulose-containing particles to be expected as a function of said period of time. Thus, the process may comprise performing a calibration whereby the process is carried out several times under the same conditions except that the period of time at which the mixture of step (ii) is maintained at temperature of from 30 to 100° C. is varied. Each time the reaction mixture is sampled. The sample is then separated into an insoluble residue containing the cellulose-containing particles and a reaction liquid component. The viscosity in water of the cellulose-containing particles is measured and this is correlated with said period of time. In the process described herein higher viscosity materials are generally produced in a short reaction time, whilst lower viscosity materials are generally produced in a longer reaction time. This is a surprising finding and, as a result of this, the process to the invention can be controlled to provide cellulose-containing particles with specific viscosity properties.

Advantageously, the process described herein can produce significantly decolourised cellulose-containing particles as the peroxide reagent both breaks down the plant material and decolourises it. However, in the case of producing higher viscosity cellulose material, the reaction time can be relatively short and decolourisation may not have occurred to the maximum or the required extent. It has been found that increasing or decreasing the temperature in a series of controlled steps can help to decolourise the cellulose-containing particles while maintaining high viscosity. Thus, in one embodiment, step (ii) may comprise heating the mixture to a temperature of between 90 and 100° C. and maintaining it at this temperature for some time, following by cooling the mixture to a temperature of between 75 and 85° C. and maintaining the mixture at this temperature for the rest of the period of time. Alternatively, step (ii) may comprise heating the mixture to and maintaining it at a temperature of between 75 and 85° C. for a period of time then increasing the temperature to between 90 and 100° C. and holding at this temperature for a period of time until the desired degree of decolourization has been achieved.

To achieve very high viscosity cellulose-containing particles, i.e. particles with a viscosity of 6800 cps or greater, without decolourisation of the particles, the mixture may only need to be heated to a relatively low temperature for a relatively short time. Below 30° C., it is not possible to obtain high viscosity cellulose-containing particles of the invention within a reasonable time frame, i.e. in a time frame of hours rather than days.

To achieve high viscosity cellulose-containing particles, i.e. particles with a viscosity of greater than 2500, for example 3000 cps or greater, with significant decolourisation of the particles and within an acceptable time frame of less than 4 hours and preferably less than 2 hours, preferably the mixture should be heated to a temperature of between 70 to 100° C. More preferably, the temperature is in the range of from 80 to 97° C., even more preferably in the range of 90 to 96° C.

To achieve low viscosity cellulose-containing particles, i.e. particles with a viscosity of less than 2500 cps, for example 1000 cps or less, with significant decolourisation of the particles, preferably the mixture should be heated to a temperature of between 90 to 100° C. and maintained at this temperature until the desired viscosity has been reached and maximum decolourisation has occurred. Preferably, the mixture is maintained at a temperature of between 90 to 100° C. for at least 1 hours.

If the mixture provided in step (i) is already hot, from the cooking of the vegetable material to provide a pulp, then it is possible that not much more additional heating of the mixture is required. If this is the case, then the heating of step (ii) has already been partially or wholly carried out in step (i). The heating step is terminated by cooling the mixture of step (ii). Preferably the mixture is cooled rapidly.

Step (ii) can also comprise a step whereby the mixture is homogenised. This can occur during heating and results in shortening the length of step (ii). Alternatively or additionally homogenisation can take place after heating. If hot peroxide is a problem for any of the equipment being used then the homogenisation can be carried out after the heating stage is completed and the material has been cooled. In one embodiment, the process of the invention involves homogenisation of the mixture of step (ii) either while the mixture is being maintained at temperature or after the mixture has been cooled down or both.

In one embodiment of the process described herein, the 35% aqueous peroxide solution may be added in an amount of 0.5% by weight or less of the weight of the herbaceous plant material (dry content) and the peroxide treatment step carried out until substantially all of the peroxide has been consumed and then terminated. In this embodiment, a particulate cellulose material with a viscosity of at least 2500 cps (at a 1 wt. % solids concentration) is obtained.

In one embodiment of the process described herein, the 35% aqueous peroxide solution may be added in a ratio of 0.5 parts peroxide solution or less to 1 part herbaceous plant material (dry content), for example 0.25 parts peroxide solution to 1 part herbaceous plant material (dry content) and the peroxide treatment carried out until substantially all of the peroxide has been consumed and the reaction immediately terminated. In this embodiment, a particulate cellulose material with a viscosity of at least 2500 cps (at a 1 wt. % solids concentration) is obtained. In one embodiment of the preferred process described herein, the conditions for the peroxide treatment step may be continued after substantially all of the peroxide has been consumed. In one embodiment, the reaction may be continued for at least a further 30 minutes, for example at least 40 minutes, or at least 60 minutes. In this embodiment, a particulate cellulose material with a viscosity of less than about 2500 cps, for example less than about 1000 cps (at a 1 wt. % solids concentration) is obtained.

Step (iii) In step (iii) of the preferred process a residue comprising the cellulose-containing particles is isolated. This can be achieved by washing and filtering the product from step (ii). The washing removes any soluble breakdown products from the reaction and any excess peroxide reagent. Excess peroxide in the product of step (ii) can also be removed by the addition of a catalyst. Washing can be achieved using a number of different processes such as centrifuge filtration (continuous or batch), microfiltration, filter pressing or simple gravity driven filtration. The peroxide level and the pH can be checked. The peroxide content should preferably be less than 30 mg/l (as measured using a peroxide indicator stick) and pH should preferably be between 6 and 9. Optionally the material can then be pressed or concentrated to lower the water content, for example to 20-50 wt. % solids. This pressed cake can then be resized by chopping/grinding to form a powder. This powder is capable of rapid re-dispersion and re-hydration when added to water-based systems.

Step (iv): The preferred process may optionally comprise a further step of contacting the cellulose-containing particles with an oxidant. The oxidant may be sodium hypochlorite. The cellulose-containing particles may be washed with water, and optionally filtered, before being contacted with the oxidant. The washed and filtered cellulose-containing particles may be reconstituted in water prior to being contacted with the oxidant. The oxidant step may be carried out at a temperature of about 60° C. or less. The oxidant may be added in a ratio of about 1 part oxidant to 2 parts solids in aqueous solution. The oxidant may be in the form of a 10% aqueous solution of the active oxidant. The temperature of the oxidant step may be maintained for at least 10 minutes, for example at least 20 minutes, up to about 30 minutes. The resultant cellulose-containing particles may be separated from the oxidant solution and washed with water until free from residual oxidant. Washing can be achieved using a number of different processes such as centrifuge filtration (continuous or batch), microfiltration, filter pressing or simple gravity driven filtration.

Step (v): The preferred process most preferably comprises a further step of homogenizing the mixture obtained from step (iii) or step (iv). The step of homogenization may take place on the filtered and dried material from step (iii) or step (iv). The step of homogenization may take place on material obtained from step (iii) or step (iv) which has been reconstituted in water. The homogenization may be carried out until a desired particle size is obtained.

Step (vi): The preferred process may comprise a further step of concentrating the cellulose particulate material or cellulose containing particles obtained to a particular concentration. The material may be concentrated to a level of, for example at least 5 wt. % solids, for example at least about 10 wt. % solids, at least about 15 wt. %, at least about 20 wt. %, at least about 25 wt. %, for example about 30 wt. % solids. At levels of 15 wt. % solids and greater, the material is able to be grated, which may be advantageous in some applications. Lower loading levels result in a paste-like consistency, which may be advantageous in other applications.

Optionally, the herbaceous plant material can be formed into microparticles before any chemical treatment, having an average particle diameter of from 100 μm to 800 μm and can be formed using any suitable means. Preferably, water or other liquid is not added to the plant material prior to comminution to form the particles. Thus, the plant material is not in the form of a slurry or suspension during the comminution step. Thus, the process can include a step of comminuting plant material in the absence of liquid to form particles of plant material. Optionally, the plant material contains less than 30 wt. % water prior to comminution, for example contains less than 20 wt. % water, for example contains less than 15 wt. % water. In some embodiments, the plant material can be dried (e.g. at ambient temperature or at higher temperatures) before being formed into particles. The comminuted material can be screened to select particles of the desired size.

The particles of plant material can be formed by grinding or milling. For example, the plant material can be processed in a mill or using a grinding apparatus such as a classifier mill to provide particles of the required diameter size.

Preferably, a combination of a mechanically acting mill, i.e. one where the plant materials is crushed and torn apart and thus comminuted between actors, and a subsequent particle sizing is employed, e.g. by gravity or density, or sieving. However, the apparatus used to produce the particles from the plant material is not particularly critical to the successful operation of the process.

Methods for comminuting are not limited in particular, and include, for example, methods by a ball mill, a rod mill, a hammer mill, an impeller mill, a high-speed mixer, attritor mills and/or a disk mill. Of these, preferred are attritor or cell mills, as described for instance in publication WO2013/167851, U.S. Pat. Nos. 3,131,875, 3,339,896, 3,084,876, or 3,670,970. In an attritor mill, a high shear field for is attained causing attrition or size reduction of the solid particulate matter. A particularly useful cell mill, coupled with sieves, may be obtained from Atritor Limited, Coventry.

Particle Size and Particle Size Distribution: The particles of parenchymal microparticulate plant material used within the process of the present invention may optionally have a mean average diameter of from 10 μm to 500 μm, preferably of from 100 μm to 300 μm. The term “diameter” refers to the measurement across the particle from one side to the other side. One skilled in the art would recognise the particles would not be perfectly spherical, but may be near-spherical, ellipsoid, disc-shaped, or even of irregular shape. One skilled in the art would also be aware that a range of diameters would be present within the starting material. To obtain the benefits of the present invention, it is not necessary to meticulously exclude very small quantities of particles which fall outside the stated particle diameter size. However, inclusion of particles of different diameter sizes within the starting material can, in some circumstances, adversely affect the quality of the end product.

Optionally, at least 60% by volume of the particles have a diameter of from 10 μm to 1000 μm, for example at least 70% by volume of the particles have a diameter of from 10 μm to 1000 μm, or at least 80% by volume of the particles have a diameter of from 10 μm to 1000 μm, or at least 85% by volume of the particles have a diameter of from 10 μm to 1000 μm, or at least 90% by volume of the particles have a diameter of from 10 μm to 1000 μm, or at least 95% by volume of the particles have a diameter of from 10 μm to 1000 μm, or even at least 98% by volume of the particles have a diameter of from 10 μm to 1000 μm. Conveniently 99% by volume of the particles have a diameter of from 10 μm to 1000 μm. In some circumstances it may be advantageous to ensure that substantially all of the particles have a diameter of from 10 μm to 1000 μm.

Depending upon the source of the starting material and/or the intended end use of the cellulose-containing material, it can be advantageous to select particles having a mean average particle diameter size within a narrower range. For example, particles of plant material used within step (a) of the process of the present invention can have a mean average diameter of from 10 μm to 500 μm, or from 100 μm to 300 μm. In some circumstances, at least 60% by volume of the particles have a diameter of from 10 μm to 500 μm, for example at least 70% by volume of the particles have a diameter of from 10 μm to 500 μm, or at least 80% by volume of the particles have a diameter of from 10 μm to 500 μm, or at least 85% by volume of the particles have a diameter of from 10 μm to 500 μm, or at least 90% by volume of the particles have a diameter of from 10 μm to 500 μm, or at least 95% by volume of the particles have a diameter of from 10 μm to 500 μm, or even at least 98% by volume of the particles have a diameter of from 10 μm to 500 μm. Conveniently, 99% by volume of the particles have a diameter of from 10 μm to 500 μm. In some circumstances it may be advantageous to ensure that substantially all of the particles have a diameter size of from 10 μm to 500 μm.

Alternatively, the particles of plant material used within step (a) of the process of the present invention can have a mean average diameter of from 200 μm to 400 μm. In some circumstances, at least 60% by volume of the particles have a diameter of from 200 μm to 400 μm, for example at least 70% by volume of the particles have a diameter of from 200 μm to 400 μm, or at least 80% by volume of the particles have a diameter of from 200 μm to 400 μm, or at least 85% by volume of the particles have a diameter of from 200 μm to 400 μm, or at least 90% by volume of the particles have a diameter of from 200 μm to 400 μm, or at least 95% by volume of the particles have a diameter of from 200 μm to 400 μm, or even at least 98% by volume of the particles have a diameter of from 200 μm to 400 μm. Conveniently 99% by volume of the particles have a diameter of from 200 μm to 400 μm. In some circumstances it may be advantageous to ensure that substantially all of the particles have a diameter of from 200 μm to 400 μm.

Particles of the required diameter and within the predetermined particle size distribution can be selected using known methods, including (but not limited to) sieving the particle mixture with one or more sieves of known sieve size.

For example, passing the parenchymal microparticulate material sample through a sieve having a mesh size of 500 μm will only allow particles having a particle diameter of 500 μm of less to pass through. The sieved material can then be sieved again using a sieve having a smaller mesh size, for example a mesh size of 300 μm. The particles retained on the smaller mesh (i.e. which do not pass through) will have a particle size distribution of 200 μm and range in size from 300 μm to 500 μm. Of course, sieves of alternative sieve size and in different combinations can be used to obtain any required particles diameter size range and particle size distribution. Alternatively, a classifier mill or other suitable means can be used to select particles of the required particle size and size distribution.

### Process for Obtaining a Material

In a first aspect, the invention relates to a process for obtaining a paper material having a high wetted conformal stability, the process comprising the steps of:
a) providing a cellulose-containing parenchymal microparticulate plant material, preferably comprising microparticles having an average particle diameter of from 10 μm to 500 μm as determined by ISO method NO. 20998-3:2017;
b) suspending the cellulose-containing parenchymal microparticulate plant material in a solution, preferably an aqueous solution;
c) mixing the suspension of cellulose-containing parenchymal microparticulate plant material with a suspension of a wood pulp, preferably an aqueous suspension of a kraft pulp;
d) providing one or more linker compounds and one or more esterification catalysts to the mixed suspension, wherein each of the one or more linker compounds comprise two or more carboxylic acid moieties, under conditions that allow the mixture to react at least in part;
e) isolating the solids from the suspension;
optionally, f) drying the isolated solids or the shaped article.

Materials prepared according to the process above were found to possess surprisingly high ultimate tensile strength. These materials may be advantageously employed to provide lighter food packaging with comparison to other paper/card products currently commercially available.

Without being bound by theory, it is believed that the parenchymal microparticulate plant material is primarily composed of cellulosic fibres functionalised with hydroxyl moieties on the outer surface, and that these hydroxyl moieties on the surface react with the carboxylic acid groups of the linker compound. It is thought that a small fraction of the linker compounds to react with hydroxyl groups of two different fibres, cross-coupling different fibres. Statistically, we expect a small fraction of the linker compounds to react with hydroxyl groups of at two far removed locations on the same fibre, such as where a fibre has folded back on itself, coupling different sections of the fibre to itself. This could result in locking intertwined fibres together. Without being bound by theory, it is believed that the cross-coupling of fibres gives rise to the unexpectedly high ultimate tensile strength of materials produced by this process.

Ultimate tensile strength, often shortened to tensile strength or ultimate strength, is the maximum stress that a material can withstand while being stretched or pulled before breaking. In brittle materials the ultimate tensile strength is close to the yield point, whereas in ductile materials the ultimate tensile strength can be higher. The ultimate tensile strength of a material is an intensive property; therefore its value does not depend on the size of the test specimen.

The ultimate tensile strength is usually found by performing a tensile test and recording the engineering stress versus strain. The highest point of the stress-strain curve is the ultimate tensile strength and has units of stress. The equivalent point for the case of compression, instead of tension, is called the compressive strength. Tensile strength is defined as a stress, which is measured as force per unit area. The unit is the pascal (Pa) (or a multiple thereof, i.a. megapascals (MPa).

Testing involves taking a small sample with a fixed cross-sectional area, and then pulling it with a tensometer at a constant strain (change in gauge length divided by initial gauge length) rate until the sample breaks. A suitable tensometer is an Instron 3342 Single Column Testing System instrument, which may be used in conjunction with software, such as Series IXs.

The parenchymal microparticulate plant material may be any as described above. The parenchymal microparticulate plant material may be provided in any suitable form, such as a powder, a slurry, a gel, a paste and/or as loose chips.

The step of suspending the microparticles in a solution may employ any suitable liquid. Preferably, the liquid is selected from water or an aqueous solution, more preferably the liquid is water.

The suspension of step b) may comprise additional chemical components known from papermaking, such as Alkyl ketene dimers (AKDs). Alkyl ketene dimers are a family of organic compounds based on the 4-membered ring system of oxetan-2-one. Attached to the oxetane ring of technically relevant alkyl ketene dimers there is typically a C₁₂₋₁₆ alkyl group in the 3-position and a C₁₃₋₁₇ alkylidene group in the 4-position. The main application of alkylated ketene dimers is in the sizing of paper and cardboard, as well as in the hydrophobation of cellulose fibres. The products thus modified are distinguished by even higher ultimate tensile strengths and less penetration of water, inks or printing inks.

The suspension of step b) may additionally comprise alkenylsuccinic anhydride (ASA). Similar to AKDs, ASA reacts with hydroxy groups of the cellulose to form an ester, anchoring the hydrophobic group to the surface. The products thus modified are distinguished by even higher ultimate tensile strengths and less penetration of water, inks or printing inks.

The suspension of step b) may additionally comprise paper sizing agents or preservation agents.

The step of mixing the suspension of microparticles with a suspension of wood pulp may be achieved by any suitable mixing means.

Pulp is a lignocellulosic fibrous material prepared by chemically or mechanically separating cellulose fibres from wood, fibre crops, waste paper, or rags. Pulp is the major raw material used in papermaking and the industrial production of other paper products, such as cardboard, cups and food packaging. Pulp may be manufactured by a variety of processes such as: (1) mechanical pulping, (2) thermochemical pulping; (3) chemi-theromechanical pulping; (4) chemical pulping [whereunder kraft process, sulphite process, soda pulping]; (5) pulp recycling and (6) organosolv pulping.

The pulp is preferably selected from a kraft pulp, sulphite pulp, a chemical-thermomechanical pulp (CTMP), a thermomechanical pulp (TMP), dissolving pulp, organosolv pulp, recycled pulp, northern bleached softwood kraft (NBSK) pulp, southern bleached softwood kraft (SBSK) pulp and/or deinked pulp, more preferably selected from a kraft pulp and a deinked pulp, most preferably the pulp is a kraft pulp.

Mechanical pulping involves grinding up wood chips, typically with grindstones embedded with silicon carbide or aluminium oxide to make stone pulp (SGW). Stone pulp is typically used for newspapers and paperboards.

Thermomechanical pulping is a process in which wood chips are heat treated (thus “thermo-”) and a mechanically refined (thus “-mechanical”). It is typically preformed in a two-stage process where the logs are first stripped of their bark and converted into small chips (20-30 wt. % water). The wood chips are then crushed and/or ground which generates heat and water vapour and softens the lignin, thus separating the individual fibres. The pulp is usually then screened and cleaned. This process gives a high yield of fibre from the timber (around 95 percent), but as the lignin has not been removed, the fibres are hard and rigid.

Chemi-thermomechanical pulping is a process in which wood chips are pre-treated with sodium carbonate, sodium hydroxide, sodium sulfate and/or other chemicals prior to refining with equipment similar to a mechanical pulping. The conditions of the chemical treatment are much less vigorous (lower temperature, shorter time, less extreme pH) than in a chemical pulping process, since the objective is to make the fibres easier to refine and not to remove lignin as in a fully chemical process. Pulps made using these hybrid processes are known as chemi-thermomechanical pulps (CTMP).

Chemical pulping is a process wherein wood chips and chemicals are combined in large vessels called digesters. There, heat and chemicals break down lignin, which binds cellulose fibres together, minimal degradation of the cellulose fibres. Chemical pulping typically provides pulps for materials requiring higher mechanical strengths. The kraft process is the dominant chemical pulping method, with the sulfite process second. Historically soda pulping was employed on a wide commercial scale.

Kraft pulp is the product of the kraft process, also known as “kraft pulping” or “the sulphate process”. The kraft process is a process for converting wood into wood pulp, which consists almost entirely of pure cellulose fibres. The kraft process typically entails treatment of wood chips with a hot mixture of water, sodium hydroxide (NaOH), and sodium sulfide (Na₂S), known in the art as “white liquor”. This treatment breaks the bonds that link lignin, hemicellulose and cellulose. The technology entails several steps, both mechanical and chemical and is the dominant method for producing paper. Suitable kraft pulps may be bleached (white kraft pulp), partially bleached (off-white pulp) or unbleached (typically brown coloured) kraft pulps. Preferably, the kraft pulp is a bleached kraft pulp.

The sulfite process produces wood pulp that is almost pure cellulose fibres by treating wood chips with solutions of sulfite and bisulfite ions. These chemicals cleave the bonds between the cellulose and lignin components of the lignocellulose. A variety of sulfite/bisulfite salts are used, including sodium (Na), calcium (Ca), potassium (K), magnesium (Mg) and ammonium (NH₄) salts. The lignin is converted to lignosulfonates, which are soluble and can therefore be separated from the cellulose fibres by mechanical means, such as isolation of the cellulose fibres by filtration. The fibres produced by this process typically do not provide materials with as high a mechanical strength as those from the kraft process.

Soda pulping is a chemical process for making wood pulp with sodium hydroxide. In the Soda-AQ process, anthraquinone (AQ) may be used as a pulping additive to decrease the carbohydrate degradation. The soda process gives pulp with lower mechanical strength than the sulfite process and kraft process.

Pulp recycling is also called deinking and produces DIP. DIP is recycled paper which has been processed by chemicals, thus removing printing inks and other unwanted elements and freed the paper fibres. DIP is typically used as raw material for papermaking. A concern about recycling wood pulp paper is that the fibres are degraded with each cycle and after being recycled 4-6 times the fibres become too short and weak to be useful in making paper. The claimed process advantageously increases the strength of recycled fibres.

Organosolv pulping uses organic solvents at temperatures above 140° C. to break down lignin and hemicellulose into soluble fragments. Using a solvent at elevated temperatures increases the lignin solubility, rendering the process more efficient in solvent. Typical solvents are methanol, ethanol, formic acid and acetic acid often in combination with water.

The step of mixing the suspension of microparticles with a suspension of pulp is preferably a step of mixing the suspension of microparticles with an aqueous suspension of pulp.

The step of mixing the suspension of microparticles with a suspension of pulp is most preferably a step of mixing the suspension of microparticles with an aqueous suspension of kraft pulp. Using kraft pulp provides materials with superior ultimate tensile strength.

Optionally, the microparticles of parenchymal plant material have a water absorption capacity (WAC) in the range of from 2 to 10. Water Absorption Capacity (WAC) is determined as follows: Material samples are weighed out in centrifuge tubes, with a minimum sample weight of 0.5 g. Distilled water is added to each sample until it is completely wet. The tubes are then centrifuged at 4000 RPM for 10 minutes. Following completion of centrifuge, the supernatant is discarded and swollen sample weighed, using the following calculation:

WAC=(S_{sw}−S_{w})/S_{w}, wherein S_{w}=Sample weight and S_{sw}=Swollen sample weight.

Preferably, the process further comprises a step (g) of modifying and/or shaping the materials obtained in step (e) and/or step (f).

Preferably, the one or more esterification catalysts are selected from Bronsted or Lewis acids, even more preferably the one or more esterification catalysts are selected from the salts of sulfuric, phosphoric, nitric, hydrochloric or acetic acid, sodium hypophosphite (NaH₂PO₂ and its hydrates), monosodium phosphate (NaH₂PO₄ and its hydrates), para-toluenesulphonic acid (4-Methylbenzene-1-sulfonic acid, PSA), phosphotungstic acid (H₃PW₁₂O₄₀.n(H₂O), where n can range from 6 to 24, preferably n=12, commonly referred to as PTA), iron (II) sulphate (FeSO₄ and its hydrates, preferably FeSO₄.7(H₂O)), most preferably the esterification catalyst is sodium hypophosphite.

Preferably, the one or more linker compounds are selected from citric acid, 2,3-Dihydroxybutanedioic acid (tartaric acid), ethanedioic acid, propanedioic acid, butanedioic acid (succinic acid), pentanedioic acid, hexanedioic acid, heptanedioic acid, octanedioic acid, nonanedioic acid, decanedioic acid, undecanedioic acid, dodecanedioic acid, tridecanedioic acid, hexadecanedioic acid, heneicosadioic acid, docosanedioic acid, triacontanedioic acid, (Z)-butenedioic acid, (E)-butenedioic acid, but-2-ynedioic acid, (Z)-pent-2-enedioic acid, (E)-pent-2-enedioic acid, 2-decenedioic acid, dodec-2-enedioic acid, (2E,4E)-hexa-2,4-dienedioic acid, (2Z,4E)-hexa-2,4-dienedioic acid, (2Z,4Z)-hexa-2,4-dienedioic acid, (RS)-penta-2,3-dienedioic acid, (2Z)-2-methylbut-2-enedioic acid, (2E)-2-methyl-2-butenedioic acid, 2-methylidenebutanedioic acid, 2-Hydroxypropanedioic acid, oxopropanedioic acid, hydroxybutanedioic acid, 2,3-dihydroxybutanedioic acid, oxobutanedioic acid, 2-aminobutanedioic acid, dioxobutanedioic acid, 2-hydroxypentanedioic acid, 2,3,4-trihydroxypentanedioic acid, 3-oxopentanedioic acid, 2-oxopentanedioic acid, 2-aminopentanedioic acid, (2R,6S)-2,6-diaminoheptanedioic acid, (2S,3S,4S,5R)-2,3,4,5-tetrahydroxyhexanedioic acid or any metal salt or any anhydride thereof, preferably selected from selected from citric acid, 2,3-Dihydroxybutanedioic acid (tartaric acid), ethanedioic acid, propanedioic acid, butanedioic acid (succinic acid), pentanedioic acid, hexanedioic acid, heptanedioic acid, octanedioic acid, nonanedioic acid, decanedioic acid, undecanedioic acid, dodecanedioic acid, tridecanedioic acid, hexadecanedioic acid, heneicosadioic acid, docosanedioic acid, triacontanedioic acid, (Z)-butenedioic acid, (E)-butenedioic acid, but-2-ynedioic acid, (Z)-pent-2-enedioic acid, (E)-pent-2-enedioic acid, 2-decenedioic acid, dodec-2-enedioic acid, (2E,4E)-hexa-2,4-dienedioic acid, (2Z,4E)-hexa-2,4-dienedioic acid, (2Z,4Z)-hexa-2,4-dienedioic acid, (RS)-penta-2,3-dienedioic acid, (2Z)-2-methylbut-2-enedioic acid, (2E)-2-methyl-2-butenedioic acid, 2-methylidenebutanedioic acid, 2-Hydroxypropanedioic acid, oxopropanedioic acid, hydroxybutanedioic acid, 2,3-dihydroxybutanedioic acid, oxobutanedioic acid, 2-aminobutanedioic acid, dioxobutanedioic acid, 2-hydroxypentanedioic acid, 2,3,4-trihydroxypentanedioic acid, 3-oxopentanedioic acid, 2-oxopentanedioic acid, 2-aminopentanedioic acid, (2R,6S)-2,6-diaminoheptanedioic acid, (2S,3S,4S,5R)-2,3,4,5-tetrahydroxyhexanedioic acid, benzene-1,2-dicarboxylic acid, benzene-1,3-dicarboxylic acid, benzene-1,4-dicarboxylic acid, 2-(2-carboxyphenyl)benzoic acid, 2,6-naphthalenedicarboxylic acid or any sodium salt thereof, more preferably the one or more linker compounds are selected from citric acid or sodium citrate, most preferably the linker compound is citric acid.

Optionally, the step e) additionally comprises adding one or more secondary linker compound, selected from a polyol. The polyol comprises at least two hydroxyl functional groups. Without being bound by theory, it is believed that a first hydroxyl reacts with a carboxylic acid moiety of a first fibre-bound linker compound to form an ester group and a second hydroxyl reacts with the carboxylic acid group of a second fibre-bound linker compound. In this way linker compounds that would otherwise be sterically precluded from linking fibre groups may be bridged by the secondary linker compound, further increasing the number of chemical bridges formed between the fibres and further increasing the strength of the resultant material. Preferably the one or more secondary linker compounds are selected from a sugar and/or glycerol, more preferably selected from glucose, sucrose, fructose and/or sorbitol, most preferably the one or more secondary linker compounds are selected from sorbitol and/or glucose.

The suspensions of steps b), c) and/or d) may additionally comprise additional chemical components known from papermaking processes. Examples of these may be nanofillers or fillers. Preferable fillers are selected from nanoclays, bentonite, talc, calcium carbonate, kaolin, silica (SiO₂), alumina (Al₂O₃), titanium oxide (Ti0₂), and/or gypsum.

The suspensions of steps b), c) and/or d) may additionally contain strengthening agents. Preferably, the strengthening agents are selected from native starch, cationic starch, anionic starch or amphoteric starch. The suspensions may also contain synthetic polymers as strengthening agents.

The suspensions of steps b), c) and/or d) may additionally comprise retention and drainage chemicals. The retention and drainage chemicals are preferably selected from cationic polyacrylamide, anionic polyacrylamide, silica, nanoclays, alum, Polydiallyldimethylammonium chloride (PDADMAC), Polyethylenimine (PEI) and/or Polyvinylamine (PVam).

The suspensions of steps b), c) and/or d) may additionally comprise other typical process or performance chemicals such as dyes or fluorescent whitening agents, defoamers, wet strength resins, biocides, hydrophobic agents and/or barrier chemicals.

The suspensions of steps b), c) and/or d) may additionally comprise a nanofiller, in the range of 1-20% by weight. Typical nanofillers can be nanoclays, bentonite, silica or silicates, calcium carbonate, talcum, etc. Preferably, at least one part of the filler is a platy filler. Preferably, one dimension of the filler should have an average thickness or length of 1 nm to 10 μm.

The suspensions of steps b), c) and/or d) may additionally comprise paper sizing agents or preservation agents.

Preferably, the process is a process for obtaining a packaging material.

In a further embodiment, process as described above further comprises a step (g) of modifying and/or shaping the materials obtained in step (e) and/or step (f).

Preferably, step (g) comprises (g1) pressing the moulded article; (g2) heating the pressed article whilst the pressed article is retained on a mould tool, or on another tool onto which the article has been transferred; and/or preferably, (g3) at least one further treatment step to finish the article and/or to remove additional water from the article.

Equally preferably, but alternatively, step (g) comprises (g1) providing the suspension obtained in step (e) and/or step (f) to a wire or carrier substrate, (g2) dewatering said suspension and (g3) drying the suspension to obtain a fibrous material. Preferably, this step (g) affords the material in the form of a film. The film may either be made with cast forming or cast coating technique, i.e. deposition of a suspension of cross-linked composition of pulp and parenchymal microparticulate plant material on a carrier substrate (e.g. metal or plastic belt) or by using a wet laid technique (e.g. a wire in a papermaking process or modified version thereof). Alternatively, the film is formed on a carrier surface (e.g. plastic, composite, or paper or paperboard substrate, onto which the film is directly formed and not removed.

In a second aspect the present invention also relates to a material obtainable by the process set out herein above, comprising a cross-linked composition comprising a pulp and parenchymal microparticulate plant material, and having an ultimate tensile strength of greater than 11 MPa, and being fully biodegradable when comprised of 95 to 96 wt. % of cellulose.

The material according to the first aspect preferably has an Oxygen Transmission Rate (OTR) value in the range of 0.01 to 4.0 cc/m²/24 h (23° C., 50% relative humidity) according to D3985-17 at a grammage between 1 and 20 gsm, preferably having an OTR value in the range of 0.01-1.0 cc/m²/24 h (23° C., 50% RH) according to D3985-17 at a grammage between 1.5 and 15 gsm, most preferably has a WVTR value in the range of 0.02-0.80 cc/m²/24 h (23° C., 50% RH) according D3985-17 at a grammage between 2 and 5 gsm.

In a preferred embodiment, the materials according to the second aspect is shaped into, or comprised in a packaging item, preferably wherein the material is shaped into, or comprised in a container for storage, dispensing, packaging, wrapping or transport, preferably comprising of containers for food and other articles, comprising bags, barrels, bottles, boxes, cans, cartons, crates, drums, jars, tanks, hoppers, accessories, closures, fittings or lids.

An advantage of this embodiment is that the shaped article will return to its original shape after being soaked in water. That is to say, the shaped article according to this embodiment advantageously possess “shape memory”.

In a preferred embodiment, the material according to the first aspect is one wherein the material possess a wear index of less than 450 mg/1000 revolutions as determined by abrasive wear test ISO 9352:2012, preferable of less than 400 mg/1000 revolutions, more preferably of less than 375 mg/1000 revolutions, even more preferably of less than 350 mg/1000 revolutions, yet more preferably of less than 325 mg/1000 revolutions and most preferably of less than 300 mg/1000 revolutions.

An advantage of this embodiment is that the shaped article is more resilient to wear-and-tear, such as might arise from shipping packaged products.

In a third aspect, the invention relates to a process according to any of the embodiments according to the first or second aspect, wherein the process further comprising the steps of:
h) contacting at least part of the surface of the material obtained in steps (e) or (f) with a coating composition comprising a binder composition comprising one or more water borne polymers and parenchymal microparticulate plant material comprising microparticles having an average particle diameter of from 10 μm to 500 μm; and
j) drying the coated object, to provide an object comprising a polymeric water and fat resistant coating.

Without being bound by theory, it is believed that the advantageously lower “fibre lift-up” (i.e. smoother surface) obtained by the method according to the first aspect (which is the first part of the process according the third aspect of the invention) allows a better oxygen and water vapour barrier to be formed. It is believed that the loose fibres of the “fibre lift-up” partially penetrate the barrier layer, reducing the effectiveness of the barrier layer to barring the passage of oxygen and/or water vapour. It is further believed that materials obtained by the third aspect of the present invention possess advantageously low WVTR and OTR rates, which are advantageous properties for use in packaging for water and/or oxygen sensitive contents. Such packaging included food, cosmetic, personal care, home care product, detergent and pharmaceutical packaging.

Preferably, the binder composition comprises a modified starch and/or a polyvinyl alcohol, preferably a hydroxypropylated starch component and/or a polyvinyl alcohol component.

Preferably, the one or more water-borne polymers are capable of drying to form a non-porous hydrophobic film, more preferably the one or more water-borne polymers are selected from the group of acrylate polymers, a co-polymer prepared from (i) acrylate monomers and (ii) at least one non-acrylate monomer starting material, water-dispersible polyurethanes, styrene acrylics, polyvinyl alcohol, a copolymer of ethylene and polyvinyl alcohol, starch, carboxymethylcellulose and combinations thereof. More preferably, the one or more water-borne polymers are selected from the group of acrylate polymers, a co-polymer prepared from (i) acrylate monomers and (ii) at least one non-acrylate monomer starting material, water-dispersible polyurethanes, styrene acrylics.

Preferably, the one or more water borne polymers are in an amount of at least 50 weight %, based on the dry weight of the coating composition.

By water borne polymers is meant that the polymers are either water soluble and/or water dispersible.

Preferably the water-soluble polymer is selected from biodegradable polymers selected from the group of polyvinyl alcohol, a copolymer of ethylene and polyvinyl alcohol, starch, carboxymethylcellulose and combinations thereof. Biodegradable is defined by EN 13432 (2000) standard “Requirements for packaging recoverable through composting and biodegradation—test scheme and evaluation criteria for the final acceptance of packaging”.

Preferably, the parenchymal microparticulate plant material is a material according to any of the embodiments of the second aspect of the invention in an amount of at least 0.25 weight %, based on the dry weight of the barrier coating.

The process was surprisingly found to provide materials in which the coating applied in step (h) was particularly strongly adhered to the surface of the material obtained in steps (e) or (f) when dry but easily delaminated when the material obtained in steps (e) or (f) is soaked in water. This is particularly advantageous for recycling where separating the various layers of a laminated material is otherwise time and labour intensive process, particularly due to the effect of easier later fragmentation during blending/grinding operations typically utilised during recycling

Preferably, material obtainable by the process according to any one of claims 14 to 16, wherein the material is recyclable according to PTS-RH 021:2012 (Draft October 2019)—Category II: Paper and board for Recycling (PfR).

In a fourth aspect, the invention relates to a material obtainable by the process according to the third aspect, wherein the surface treated object has a Water Vapor Transmission Rate (WVTR) value in the range of 0.25 to 4.0 cc/m²/24 h (23° C., 50% relative humidity) according to ASTM F-1249-06 at a coating weight grammage between 1 and 20 gsm, preferably has a WVTR value in the range of 0.5-2.0 cc/m²/24 h (23° C., 50% RH) according to ASTM F-1249-06 at a coating weight grammage between 1.5 and 15 gsm, most preferably has a WVTR value in the range of 1-1.5 cc/m²/24 h (23° C., 50% RH) according to ASTM F-1249-06 at a coating weight grammage between 2 and 5 gsm.

Preferably, the process comprises the additional step j) before step h), wherein step j) comprises contacting at least part of the surface of the material or shaped article with a binder composition comprising a polymer and parenchymal microparticulate material, preferably wherein the binder composition comprises a the one or more water-borne polymers are capable of drying to form a non-porous hydrophobic film, more preferably the binder composition comprises a polyacrylate, a co-polymer prepared from (i) acrylate monomers and (ii) at least one non-acrylate monomer starting material, water-dispersible polyurethanes, styrene acrylics modified starch and/or a polyvinyl alcohol, most preferably wherein the binder composition comprises a hydroxypropylated starch and a polyvinyl alcohol.

A fifth aspect of the invention relates to the use of a cellulose-containing parenchymal microparticulate material, optionally comprising microparticles having an average particle diameter of from 10 μm to 500 μm, to enhance the tear strength and water resistance of a paper pulp when crosslinked with a linker, and/or to enhance the biodegradability thereof.

A sixth aspect of the invention relates to the use of a cellulose-containing parenchymal microparticulate material, optionally comprising microparticles having an average particle diameter of from 10 μm to 500 μm, to enhance the Water Vapor Transmission Rate (WVTR) of paper pulp articles materials when used in a coating composition; and/or to enhance the biodegradability thereof.

A seventh aspect of the invention relates to an aqueous barrier coating composition for coating a substrate comprising:
(i) a water-soluble polymer selected from the group of acrylate, a co-polymer prepared from (i) acrylate monomers and (ii) at least one non-acrylate monomer starting material, water-dispersible polyurethanes, styrene acrylics polyvinyl alcohol, a copolymer of ethylene and polyvinyl alcohol, starch, carboxymethylcellulose and combinations thereof in an amount of at least 50 weight %, based on the dry weight of the barrier coating; and
(ii) a material according to any of the embodiments of the second or fourth aspects of the invention in an amount of at least 0.25 weight %, based on the dry weight of the barrier coating.

The coating composition allows for a coating to be applied to a substrate, such as paper, paperboard or cardboard, and provide an oxygen, grease and water-resistant layer which can be heat sealed.

Preferably the water-soluble polymer is selected from biodegradable polymers selected from the group of polyvinyl alcohol, a copolymer of ethylene and polyvinyl alcohol, starch, carboxymethylcellulose and combinations thereof. Biodegradable is defined by EN 13432 (2000) standard “Requirements for packaging recoverable through composting and biodegradation—test scheme and evaluation criteria for the final acceptance of packaging”.

Preferably, the ratio of the water-soluble and/or water-dispersible polymer to the material according to any of the embodiments of the second or fourth aspects of the invention is in the range from 400:1 to 6:1 on a dry weight basis, more preferably in the range from 100:1 to 8:1, even more preferably in the range from 50:1 to 10:1 and most preferably in the range of 25:1 to 15:1.

An eighth aspect of the invention relates to a method of coating a substrate with the coating composition according to the seventh aspect of the invention. The substrate may be coated with any existing liquid coating method. Preferable the substrate is coated by a method selected from spraying, rod-coating, spin coating, curtain coating, dip-coating, flexographic printing and inkjet printing.

A ninth aspect of the invention relates to a laminated material comprising:
(1) a first layer comprising a material according to any embodiment of the second and/or fourth aspect of the present invention; and
(2) a second layer comprising a water-soluble polymer selected from the group of polyvinyl alcohol, a copolymer of ethylene and polyvinyl alcohol, starch, carboxymethylcellulose and combinations thereof in an amount of at least 50 weight %, based on the dry weight of the second layer; and a material according to any of the embodiments of the second aspect of the invention in an amount of at least 0.25 weight %, based on the dry weight of the second layer.

Preferably the water-soluble polymer is selected from biodegradable polymers selected from the group of polyvinyl alcohol, a copolymer of ethylene and polyvinyl alcohol, starch, carboxymethylcellulose and combinations thereof. Biodegradable is defined by EN 13432 (2000) standard “Requirements for packaging recoverable through composting and biodegradation-test scheme and evaluation criteria for the final acceptance of packaging”.

Preferably, the ratio of the water-soluble polymer to the material according to any of the embodiments of the second aspect of the invention is in the range from 400:1 to 6:1 on a dry weight basis, more preferably in the range from 100:1 to 8:1, even more preferably in the range from 50:1 to 10:1 and most preferably in the range of 25:1 to 15:1.

Preferably, the first and second layer are in direct contact. This was surprisingly found to afford a material in which the layers are firmly adhered when the first layer is dry, but quickly delaminate when the first layer is soaked in water. This advantageously allows for easy separation of the laminate layers during recycling, reducing the time and effort required to separate the layers into different recycling streams.

A tenth aspect of the invention concerns a barrier coating for a paperboard substrate comprising: (i) a water borne polymer selected from the group of acrylate polymers, a co-polymer prepared from (i) acrylate monomers and (ii) at least one non-acrylate monomer starting material, water-dispersible polyurethanes, styrene acrylics, polyvinyl alcohol, a copolymer of ethylene and polyvinyl alcohol, starch, carboxymethylcellulose and combinations thereof in an amount of at least 50 weight %, based on the dry weight of the barrier coating; and (ii) a parenchymal microparticulate plant material obtainable from herbaceous plant material as described above.

An eleventh aspect of the invention concerns a recyclable packaging material obtainable from any embodiment of the first aspect, or comprising a material according to any embodiment of the second aspect, obtainable from any embodiment of the third aspect, or comprising a material according to any embodiment of the fourth aspect.

In a preferable embodiment, the recyclable packaging material is selected from food, cosmetic, home care product, detergent, personal care and pharmaceutical packaging.

In a preferable embodiment, the recyclable packaging material is selected from primary, secondary or tertiary packaging.

In a preferable embodiment the recyclable packaging material comprises a heat seal.

In a preferable embodiment, the recyclable packaging material has been hot-pressed or thermoformed.

In a preferable embodiment, the recyclable packaging material is a heat-sealable pouch or a heat sealed pouch.

In a preferable embodiment, the recyclable packaging material is a heat sealable tray or a heat sealed tray, preferably a heat sealable tray suitable for microwaving the contents or a heat sealed microwave food tray, more preferably a heat sealable tray suitable for microwaving the high water activity meals or a heat sealed microwave food tray comprising a high water activity meal. More preferably, the tray itself comprises the recyclable material. The combination of the high grease, oxygen and water vapour barrier properties of such a recyclable packaging material renders it particularly resistant to the conditions of storing microwave meals, which inherently have a high water activity due the requirements of microwave heating. Such packaging is advantageous over known plastic heat sealable trays in ease of recycling.

In a preferable embodiment, the recyclable packaging material is a multilayer packaging material, preferably a multilayer packaging material selected from a multiwall paper sack, a laminated carton, a bottle or a tetra brik aseptic carton package, more preferably the recyclable packaging material is a fibre-based bottle or a tetra brik aseptic carton package, most preferably the recyclable packaging material is tetra brik aspectic carton package.

A twelfth aspect of the invention relates to the use of the recyclable packaging material according to any embodiment of the eleventh aspect as primary, secondary or tertiary packaging.

Preferred or alternative features of each aspect or embodiment of the invention apply mutatis mutandis to each aspect or embodiment of the invention (unless the context demands otherwise).

The term “comprising” as used herein means consisting of, consisting essentially of, or including and each use of the word “comprising” or “comprises” can be independently revised by replacement with the term “includes”, “consists essentially of or “consists of”.

Any modifications and/or variations to described embodiments that would be apparent to one of skill in art are hereby encompassed. Whilst the invention has been described herein with reference to certain specific embodiments and examples, it should be understood that the invention is not intended to be unduly limited to these specific embodiments or examples.

The present invention is now further described with reference to the following non-limiting examples.

### EXAMPLE 1A

Sugar-beet pellets obtained from a sugar extraction process were subjected to a milling step in an attritor mill, selecting a composition comprising at a weight average particles size of from 100 μm to 300 μm.

The sugar beet was then subjected to a hydrogen peroxide reaction in water. All hydrogen peroxide reactions were carried out in a 5 L glass reactor with a total reaction mixture volume of 4000 ml. Water (3879 ml) in the reactor was heated to 90° C. and hydrogen peroxide (40 g) was added. Sugar beet powder (89 g, 89% solids, particle diameter size of 100-300 μm) was added directly to peroxide water mixture. After the required PH drop or reaction time the reaction was quenched by pouring the mixture through a filter mesh with 152 μm diameter holes. Samples were filtered using the mesh filter, by mixing the reaction liquid with clean water and pouring this onto a filter screen. The paste was then removed from the filter, clean water was added and then the new mixture poured back over the mesh filter. This process was repeated as required to ensure good washing.

After the hydrogen peroxide level in the washed paste had dropped to less than 1 ppm, the bleach reaction was carried out by diluting the washed paste to 0.5% solids. The diluted mixture was heated to 60° C. and bleach was then added in an amount of 2:1 ratio to solids. The same filter process was applied as had been conducted after the peroxide stage and the resultant clean paste was prepared for homogenisation.

Homogenisation was carried out at 0.5% solids with a benchtop Silverson homogeniser. The volume of the homogenised solution was around 4000 ml, (adjusted as necessary to always ensure 0.5% solids). After 30 minutes at 7500 rpm the smooth suspension was poured gently into a filter cloth and left to drain until the solids were greater than 1%. A pre-press viscosity was taken, and the sample was then pressed between absorbent cloths in a hydraulic press.

The reaction time was 4 hours 15 minutes and the pH of the mixture at the end of the peroxide reaction was 3.30. The reacted mixture was filtered using a cloth filter.

### EXAMPLE 1B

900 g of sugar beet pellets were washed and hydrated by adding them to warm water, with dirty water being drained through a sieve. This sugar beet hydrate was placed in a large bucket in excess water and agitated before being scooped out with a colander and washed with water, to ensure that no stones/grit entered the next stage of processing.

The washed sugar beet was then cooked for 3 hours at 100° C., before being homogenised using a Silverson FX homogeniser fitted with initially coarse stator screens and moving down to the small holed emulsifier screen (15 minutes process time for each screen). The solids were measured using an Oxford solids meter and the mixture adjusted to 2% solids by addition of clean water.

The mix was then placed in a 25-litre glass reaction vessel and the dry solids content in the vessel was calculated. Peroxide based on ratio of aqueous peroxide solution (at 35%) to the dry solids of 0.25:1 was added when the mix was heating. The temperature was maintained for 6 hours at 90° C. (once it reached 90° C.), by which time the pH had dropped from around 5 to 3 or less. Bleaching was then carried out by re-suspending the washed material in clean water and placing it back in the vessel. Bleaching was performed at 60° C., with a 2:1 bleach (2 parts of bleach solution with 10% active chlorine to 1 part solids, for 30 minutes).

The material was then homogenised for 30 minutes on the fine slotted stator screen of the Silverson FX homogeniser

The material was then drained through a filter and pressed between absorbent cloths to a desired final solids content. Resuspension of the solids in water at 1 wt. % solids resulted in a viscosity of 1500 cps. The viscosity of the pulp was then measured at a concentration of 1 dry wt. % in water using a Brookfield Viscometer DVII+Pro EXTRA, with RV spindle heads, run at 10 rpm and 20° C. Viscosity was recorded in centipoise (cps).

### EXAMPLE 2

### Water Absorption Capacity (WAC)

Water Absorption Capacity (WAC) was determined as follows: Material samples were weighed out in centrifuge tubes, with a minimum sample weight of 0.5 g. Distilled water was added to each sample until it was completely wet. The tubes were then centrifuged at 4000 RPM for 10 minutes.

Following completion of centrifuge, the supernatant was discarded, and swollen sample weighed, using the following calculation:

WAC=(S_{sw}−S_{w})/S_{w}, wherein S_{w}=Sample weight and S_{sw}=Swollen sample weight.

### Raw Cellulose of Example 1

Sample weight=0.7781
Swollen sample weight=5.2969
WAC=5.81

Preferably, the cellulose starting material particles according to the invention have a WAC in the range of from 2 to 10.

### COMPARATIVE EXAMPLE 3: MATERIAL COMPRISING PAPER PULP (UNBLEACHED KRAFT PULP)

1001 g of water was added to 3.50 g paper pulp [unbleached Kraft pulp, softwood, pine]. The sample was blended for 15 minutes, using Optimum 9400 Blender. To this blend was added to it 28.14 g of citric acid and 13.98 g of sodium hypophosphite. The sample was transferred to a 2-litre beaker and mixed for 1 hour. The mixture was filtered using a filter connected to a vacuum pump, and partially dried under vacuum for 10 minutes to remove residual solution and form a wet, disk-shaped product. The wet disk-shaped product was heated between two hot plates (160° C.) and compressed via a hydraulic pump with a weight setting of 1 tonne.

### EXAMPLE 4: CROSS-LINKED MATERIAL COMPRISING MATERIAL ACCORDING TO EXAMPLE 1A [5 WT. % WITH RESPECT TO THE PAPER PULP]

1003 g of water was added to 3.77 g of paper pulp [unbleached Kraft pulp, softwood, pine]. The sample was blended for 15 minutes using Optimum 9400 Blender. 0.89 g of wet parenchymal microparticulate material [0.19 g of material according to Example 1A, 0.70 g water] was added to the sample, blended for 5 minutes and then left to sit for 15 minutes. To the sample was added 28.05 g of citric acid and 14.06 g of sodium hypophosphite. The sample was transferred to a 2-litre beaker and mixed for 1 hour. The mixture was filtered using a filter connected to a vacuum pump, and partially dried under vacuum for 8 minutes to remove residual solution and form a wet, disk-shaped product. The wet, disk-shaped product was heated between two hot plates (160° C.) and compressed via a hydraulic pump with a weight setting of 1 tonne.

### EXAMPLE 5: CROSS-LINKED MATERIAL COMPRISING MATERIAL ACCORDING TO EXAMPLE 1A [10 WT. % WITH RESPECT TO THE PAPER PULP]

1001 g of water was added to 3.53 g of paper pulp [unbleached Kraft pulp, softwood, pine]. The sample was blended for 15 minutes using Optimum 9400 Blender. 1.75 g of wet parenchymal microparticulate material [0.35 g of solids according to Example 1A, 1.40 g water] was added to the sample blended for 5 minutes and left to sit for 15 minutes. To the sample was added 28.10 g of citric acid and 14.41 g of sodium hypophosphite. The sample was transferred to a 2-litre beaker and mixed for 1 hour. The mixture was filtered using a filter connected to a vacuum pump, and partially dried under vacuum for 8 minutes to remove residual solution and form a wet, disk-shaped product.

The wet, disk-shaped product was heated between two hot plates (160° C.) and compressed via a hydraulic pump with a weight setting of 1 tonne.

### EXAMPLE 6: CROSS-LINKED MATERIAL COMPRISING EXAMPLE 1A [20 WT. %]

3.52 g paper pulp [unbleached Kraft pulp, softwood, pine] was added to it was 998 g of water. The sample was blended for 15 minutes using Optimum 9400 Blender. 6.74 g of Example 1B was added to the sample blended for 5 minutes and left to sit for 15 minutes. To the sample was added 28.20 g of citric acid and 14.20 g of sodium hypophosphite. The sample was transferred to a 2-litre beaker and mixed for 1 hour. The sample was transferred to a 2-litre beaker and mixed for 1 hour. The mixture was filtered using a filter connected to a vacuum pump, and partially dried under vacuum for 10 minutes to remove residual solution and form a wet, disk-shaped product. The wet disk-shaped product was then heated between two hot plates (160° C.) and compressed via a hydraulic pump with a weight setting of 1 tonne.

### COMPARATIVE EXAMPLE 7: WATER ABSORPTION AND MECHANICAL STRENGTH OF CROSS-LINKED PAPER PULP PREPARED ACCORDING TO COMPARATIVE EXAMPLE 3

1002 g of water was added to 3.52 g paper pulp [unbleached Kraft pulp, softwood, pine]. The sample was blended for 15 minutes using Optimum 9400 Blender and then left to sit for a further 15 minutes. To the sample was added 28.29 g of citric acid and 14.13 g of sodium hypophosphite. The mixture was filtered using a filter connected to a vacuum pump, and partially dried under vacuum for 8 minutes to remove residual solution and form a wet, disk-shaped product. The wet, disk-shaped product was heated between two hot plates (160° C.) and compressed via a hydraulic pump with a weight setting of 1 tonne.

Four “strips” of 4 mm×1.5 mm were cut out from the “disc shape” and submerged in water. The weight of the four “strips” measured, at 0, 1, 2, 3, 4, 5, 6, 7, 8, 9, 10, 12, 14, 16, 18, 20, 25, 30, 35, 40, 50 and 60 minutes. Mechanical properties of the strips were measured using an Instron 3342 Single Column Test Machine to perform tensile tests of the strips.

### EXAMPLE 8: WATER ABSORPTION TEST OF MATERIAL COMPRISING MATERIAL ACCORDING TO EXAMPLE 6

Four “strips” 4 mm×1.5 mm were cut out from the “disc shape” and submerged in water. Before each strip was weighed it was “dabbed” dry using paper towels. The weight of the four “strips” measured at 0, 15, 30, 45, 60, 75 minutes.

### EXAMPLE 9: DRY STRENGTH ASSESSMENT

Stress/strain measurements were performed using an Instron 3342 Single Column Testing System instrument, in conjunction with software Series IXs. Samples were prepared according to the Examples above and a 60×60 mm square cut from the heat-treated, pressed disc-shaped end product. Each sample was then cut into six 60×10 mm thin strips which were used to for determining the stress/strain relationship by measuring their mechanical properties using a tensile test. This meant six data sets were taken for each sample to improve reliability and accuracy of the measurements. The thickness and width, as well as the difference in mm between both clamps, was measured for each strip and the data input into the software package Series IXs. Percent strain maximum and maximum strength were recorded.

Strain and Strength measurements were taken from “disc shape” and the average ultimate strength value calculated (in MPa). Data was categorised and put into table format. The following tables include control samples, the type of Curran additive and whether the sample was tested dry or wet with their respective max strength value.

TABLE 1
Mechanical strength of dry materials having
undergone cross-linking treatment.

| | Average (mean) |
|---|---|
| | ultimate strength |
| Material | value (MPa) |
| Unbleached kraft paper pulp treated according to | 10.2 |
| Comparative Example 3 | |
| Cross-linked material of Example 4 [5 wt. % of | 14.5 |
| material according to Example 1A with respect to the | |
| pulp] | |
| Cross-linked material of Example 5 [10 wt. % of | 16.3 |
| material according to Example 1A with respect to the | |
| pulp] | |
| Cross-linked material of Example 6 [20 wt. % of | 15 |
| material according to Example 1A with respect to the | |
| pulp] | |

### EXAMPLE 10: WET STRENGTH & INTEGRITY ASSESSMENT

Tensile stress/strain measurements were performed using an Instron 3342 Single Column Testing System instrument, in conjunction with software Series IXs. Samples were prepared according to the Examples above and a 60×60 mm square cut from the heat-treated, pressed disc-shaped end product. From each sample four strips 4 mm×1.5 mm were cut out and submerged in water. Before each strip was weighed it was “dabbed” dry using paper towels. The weight of the four “strips” measured at 0, 15, 30, 45, 60, 75 minutes.

TABLE 2
Mechanical strength of wet cross-linked materials
after 75 minutes immersion in water.

| | Average (mean) |
|---|---|
| | ultimate tensile |
| Material | strength value (MPa) |
| Cross-linked material comprising 20 wt. % | 1.9 |
| Example 6 | |
| Unbleached Kraft paper pulp (softwood pine) | 0.5 |
| treated according to Comparative Example 3 | |

From Table 2 it is clear to see that cross-linked material comprising parenchymal microparticulate plant material is stronger whilst wet (1.9 MPa) than cross-linked unbleached Kraft paper pulp (0.5 MPa), after 75 minutes soaking in water. The cross-linking step is also clearly demonstrated to provide increased tensile strength (1.9 MPa) compared to non-crosslinked materials (1.5 MPa).

### COMPARATIVE EXAMPLE 11A: SMOOTH THERMOFORMING KRAFT UNBLEACHED CUP

An aqueous suspension comprising cellulosic fibres with a solids content of 1 wt. % was provided, wherein the solids are kraft unbleached pulp. A mesh forming mould was immersed into the suspension. By application of vacuum, a layer of the cellulosic fibres was a moulded on to the metal mesh. The wet moulded object was transferred from the forming mould to the concave drying mould, which was at 200° C. The moulded object was dried between the concave and convex moulds (each at 200° C.) by application of heat and pressure (100 bar) for 5 minutes. The object was removed from the moulding machine and is ready for subsequent processing (e. g. trimming, surface processing etc.).

FIG. 4(a) depicts a representative moulded article. The moulded article prepared from normal bleached kraft pulp exhibits “fibre lift-up”, which is where the fibres extend from the surface of the moulded article.

### EXAMPLE 11B: SMOOTH THERMOFORMING CROSS-LINKED CUP OF THE MATERIAL OF EXAMPLE 5

An aqueous suspension comprising cellulosic fibres with a solids content of 1 wt. % was provided, wherein the solids were the cross-linked material produced according to Example 5 without the step of heating or compressing between two hot plates. A mesh forming mould was immersed into the suspension. By application of vacuum, a layer of the cellulosic fibres was moulded on to the metal mesh. The wet moulded object was transferred from the forming mould to the concave drying mould, which was at 200° C. The moulded object was dried between the concave and convex moulds (each at 200° C.) by application of heat and pressure (100 bar) for 5 minutes. The object was removed from the moulding machine and was ready for subsequent processing (e. g. trimming, surface processing etc.). The moulded article comprises approximately 4 wt. % of water after the moulding process.

FIG. 4(b) depicts a moulded article prepared under identical conditions formed from cross-linked material according to the invention. Whereas the moulded article prepared from normal bleached kraft pulp exhibits “fibre lift-up”, which is where the fibres extend from the surface of the moulded article, the moulded article prepared from cross-linked material according to the invention does not. This allows better barrier layer formation and thinner barrier layer formation.

The material according to the present invention prevents “fibre lift-up”, which is beneficial when depositing a liquid coating and a consequent transmission of moisture under the coating via sticking up fibres. Thus, the liquid moisture barrier is enhanced over comparative example 11a even if the same coating is applied. The fibre detachment in a normal pulp and its absence in the cross-linked pulp is demonstrated in FIG. 4a & b.

### EXAMPLE 12: CUP COATING

A cup prepared from material according to the invention in Example 11b was spray-coated with:
12a—an acrylic polymer-based barrier layer
12b—a first interstitial layer of a commercial PVOH derivative (Exceval HR-3010) and then an acrylic polymer-based barrier layer
12c—a first interstitial layer of starch (Solcoat P55) and then an acrylic polymer-based barrier layer

### EXAMPLE 13: BARRIER PERFORMANCE ANALYSIS

Coated cups according to Example 12 were assessed for their barrier performance, namely oxygen and water vapor transmission rates. Water Vapor Transmission Rate (WVTR) values were obtained according to ASTM F-1249-06 using a Permatran-W Model 3/34 at 38° C. and 90% relative humidity. Oxygen Transmission Rate (OTR) values determined according to D3985-17 using an OxTran Model 2/22 H at 23° C. and 50% relative humidity.

TABLE 3
Oxygen and water vapor transmission rates

| | WVTR | OTR |
|---|---|---|
| Material | (g/m²/24 h) | (cc/m²/24 h) |
| Cup coated according to Example 12a | 3.6 | 0.02 |
| (straight onto fibres) | | |
| Cup coated according to Example 12b | 4.8 | Below |
| (interstitial layer of a commercial PVOH | | sensitivity |
| derivative (Exceval HR-3010) | | limit |
| Cup coated according to 12c (interstitial | 22.3 | 0.8 |
| layer of starch (Solcoat P55)) | | |

### EXAMPLE 14: REPULPABILITY OF AN ARTICLE ACCORDING TO THE INVENTION

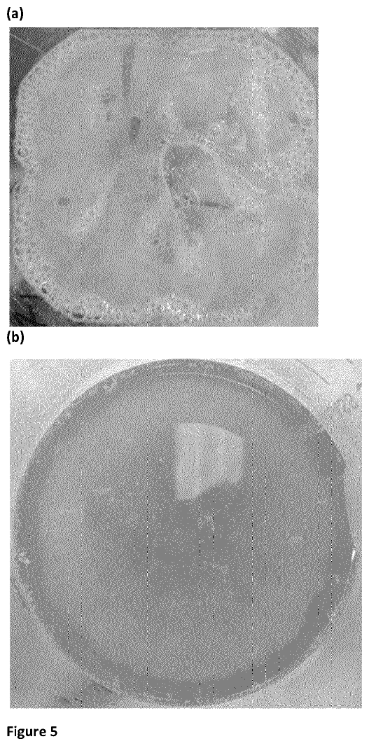

Comparative 14a: A polymer coated article (commercial orange juice carton with a plastic barrier layer) was cut into 2-3 cm pieces with scissors, mixed with water and placed into a food blender with blunted blades to simulate the commercial repulping process. Blending was carried out for 50 minutes. FIG. 5(a) depicts the result of 50 minutes of simulated repulping of a commercially available orange juice carton with a conventional plastic barrier layer. It is clear to see that the plastic barrier layer is almost entirely intact as a continuous plastic sheet. This is unsuitable for further use as a pulp for paper manufacturing as the plastic sheet needs to be removed.

14b: A polymer coated article prepared according to example 12a was cut into 2-3 cm pieces with scissors, mixed with water and placed into a food blender with blunted blades to simulate the commercial repulping process. Blending was carried out for 50 minutes. FIG. 5(b) depicts the result of 50 minutes of simulated repulping of an article according to the invention coated with an acrylic comprising barrier layer. It is clear to see that a homogeneous suspension has been formed and no continuous plastic sheet elements can be seen. The material was found to be suitable as a pulp for further paper manufacture, demonstrating the recyclability of the material and articles of the current invention.

### EXAMPLE 15: SOIL DEGRADATION TEST

Samples of coated paper were prepared, wherein 15a was coated with a barrier coating of acrylic polymer; and 15b was coated with a barrier coating of mixture of acrylic polymer and 5 wt. % parenchymal microparticulate plant material on a solids basis.

The paper samples were cut into 10 cm-by-10 cm squares, sandwiched in nylon mesh and then placed in garden soil. The soil was kept moist and maintained at 20° C. for 10 weeks. The samples were then uncovered and photographed.

Sample 15a exhibited minimal biological degradation. The coating remains largely intact even though the pulp fibres have been degraded away. Sample 15b exhibited high biological degradation.

There was some residual coating left but it is significantly less dense and more fragmented showing that it has degraded more than the control.

Accordingly, it was found that addition of parenchymal microparticulate material to the acrylic coating on paper greatly increases the biodegradability.

### EXAMPLE 16: COMPARATIVE ABRASION TEST OF PAPER MADE ACCORDING TO THE FIRST ASPECT OF THE INVENTION

Paper made according the first aspect of the invention, as well as paper made by comparable methods, were analysed by abrasive wear tests [ISO 9352:2012]. The lower the wear index value obtained, given in mg/1000 revolutions, the better the abrasive strength.

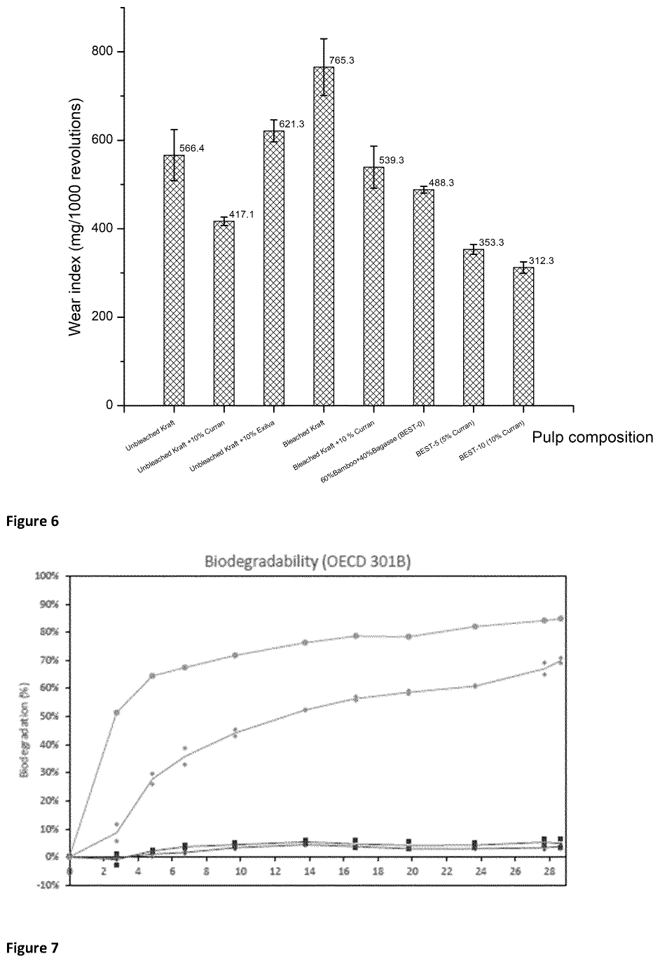

The results of this abrasion test are reproduced in FIG. 6. FIG. 6 is bar graph of the average wear index on the y axis (mg/1000 revolutions) of the of paper derived from various pulp compositions (along y-axis). Reading from left to right along the y-axis, the paper is derived from pulp compositions are as follows:
unbleached kraft [disk shaped paper prepared according to Example 3];
unbleached kraft with 10 wt. % of parenchymal microparticulate material [disk shaped paper prepared according to Examples 1A and 5];
unbleached kraft with 10 wt. % of an insoluble wood-fibre derived Microfibrillated cellulose (MFC, Exilva, commercially available from Borregaard) [disk shaped paper prepared according to Examples 1A and 5, using MFC in place of the parenchymal microparticulate material];
bleached kraft [disk shaped paper prepared according to Example 3, using bleached kraft pulp in place of unbleached kraft pulp];
bleached kraft with 10 wt. % of parenchymal microparticulate material [disk shaped paper prepared according to Examples 1A and 5, using bleached kraft pulp in place of unbleached kraft pulp];
bamboo and bagasse (60 wt. % bamboo, 40 wt. % bagasse) [disk shaped paper prepared according to Example 3, using bamboo and bagasse pulp in place of unbleached kraft pulp];
bamboo and bagasse (60 wt. % bamboo, 40 wt. % bagasse) with 5 wt. % of parenchymal microparticulate material [disk shaped paper prepared according to Examples 1A and 4, using bamboo and bagasse (60:40 w:w) in place of unbleached kraft pulp]; and
bamboo and bagasse (60 wt. % bamboo, 40 wt. % bagasse) with 10 wt. % of parenchymal microparticulate material [disk shaped paper prepared according to Examples 1A and 5, using bamboo and bagasse (60:40 w:w) in place of unbleached kraft pulp].

From this graph it clear to see that:
(1) paper produced according to the first aspect of the invention possesses better abrasive strength than comparative paper produced without cross-linked parenchymal microparticulate material;
(2) paper produced in a comparative way to the first aspect of the invention using cross-linked wood-fibre derived MFC possesses worse abrasive strength than paper produced with cross-linked parenchymal microparticulate material;
(3) paper produces with bleached kraft is lower than that of unbleached kraft. However, the paper made according to the first aspect of the invention with bleached kraft possess comparable abrasive strength to paper made with unbleached kraft alone. This means that material obtained according to the first aspect of the invention advantageously allows bleached kraft paper to be used in situations where the abrasive strength of unbleached kraft paper is typically required. This allows, by way of illustrative example, packaging with a white colour typically obtained from bleached kraft paper with the fiber bonding strength typically obtained from unbleached kraft paper.

### EXAMPLE 17: COMPARISON OF THE WATER VAPOUR TRANSMISSION RATE (WVTR) AND OXYGEN TRANSMISSION RATE (OTR) OF A CONTAINER WITH A POLYMERIC WATER AND FAT RESISTANT COATING PREPARED ACCORDING TO THE THIRD ASPECT OF THE PRESENT INVENTION WITH A CONTAINER PREPARED IN A COMPARABLE METHOD

Containers were prepared as follows:
Example 17A according to the third aspect [using material prepared according to Example 5, smooth thermoforming according to Example 11B, and then coated according to Example 12A]; and
Comparative Example 17B in a method comparable to the third aspect, but using wood-fibre derived MFC [using material prepared according to Example 5, replacing the parenchymal microparticulate material with wood-fibre derived MFC, smooth thermoforming according to Example 11B, and then coated according to Example 12A].

The Water Vapour Transmission Rate (WVTR) of these containers were determined by weighing bottles filled with desiccant (dry CaCl₂) once a day during 7 days at regular time intervals [according to ISO/IEC 17025:2017]. The equipment used was a Balance Mettler AT400, at 23° C., with test gas (Air—20.9% O₂, 50% RH, with an exposed area of 120,082 m² and conditioning of >24 hours are 23.0° C. and 50% RH. The results are reproduced in Table 4 below.

The results clearly establish:
(1) Containers obtained according to the third aspect of the present invention possessed advantageously lower Water Vapour Transmission Rates than containers prepared by an analogous method (WVTR of 1.42 g/m²/24 h vs. 7.10 g/m²/24 h); and
(2) Containers obtained according to the third aspect of the present invention possessed advantageously more consistent Water Vapour Transmission Rates than containers prepared by an analogous method (maximum deviation of WVTR of 1.68 g/m²/24 h vs. 5.04 g/m²/24 h).

The Oxygen Transmission Rate (OTR) of these containers were determined by invasive gas sampling [ISO/IEC 17025:2017]. The equipment used was a Dansensor CheckPoint 3, at 23° C., using a test gas (Air: 20.9% O₂, 50% RH), with an exposed area of 120,082 cm² and volume of 106 cm³ and conditioning of >24 hours at 23.0° C. and 50% RH. The results are reproduced in Table 4 below. The results clearly establish that containers obtained according to the third aspect of the present invention possessed advantageously lower Oxygen Transmission Rates than containers prepared by an analogous method (OTR of approximately 5000 cc/m²/24 h vs. approximately 24000 cc/m²/24 h).

Without being bound by theory, it is believed that the lower “fibre lift-up” (i.e. smoother surface) obtained by the method according to the first aspect (which is the first part of the process according the third aspect of the invention) allows a better oxygen and water vapour barrier to be formed. It is believed that the loose fibres of the “fibre lift-up” partially penetrate the barrier layer, reducing the effectiveness of the barrier layer to barring the passage of oxygen and/or water vapour.

It is believed that materials obtained by the third aspect of the present invention possess advantageously low WVTR and OTR rates, which are advantageous properties for use in packaging for water and/or oxygen sensitive contents. Such packaging included food, cosmetic, home care product, detergent, personal care and pharmaceutical packaging.

TABLE 4
Oxygen and Water Vapour Transmission Rates (OTR/WVTR)

| Material | OTR (cc/m²/24 h) | WVTR (g/m²/24 h) |
|---|---|---|
| Example 17A | 5081; | 1.66 ± 0.03; |
| | 4373; | 0.65 ± 0.02; |
| | 5443; and | 1.13 ± 0.03; and |
| | 5314. | 2.23 ± 0.03. |
| | Average: 5053 | Average: 1.42 |
| Comparative Example 17B | 21,555; | 8.02 ± 0.02; |
| | 24,337; | 10.07 ± 0.02; |
| | 25,020; and | 5.29 ± 0.03; and |
| | 25,975. | 5.03 ± 0.02. |
| | Average: 24221 | Average: 7.10 |

EXAMPLE 18: MIGRATION TESTS OF A CONTAINER WITH A POLYMERIC WATER AND FAT RESISTANT COATING PREPARED ACCORDING TO THE THIRD ASPECT OF THE PRESENT INVENTION

Containers were prepared according to the third aspect [using material prepared according to Example 5, smooth thermoforming according to Example 11B, and then coated according to Example 12A]. The containers were filled with food simulant and tested for their migration properties, and the results reproduced in Tables 5 and 6. As can be seen from the results in Tables 5 and 6, the containers prepared according to the third aspect of the invention are advantageously resistant to migration of materials, and consequently advantageously useful for use in packaging for water and/or oxygen sensitive contents. Such packaging included food, cosmetic, home care product, detergent, personal care and pharmaceutical packaging.

TABLE 5
Migration Properties - ethanol and acetic acid

| | | | | Max. | | |
|---|---|---|---|---|---|---|
| | | | | Permissible | Method | Method |
| Food Simulant | Test | Test time | Temperature | limit⁽³⁾ | uncertainty | LOQ⁽³⁾ |
| 10% v/v ethanol | 10% v/v | 30 days ± | 5° C. ± 1° C. | 10 mg/dm²⁽³⁾ | 10% | 0.5 |
| | ethanol | 5 h | | | | mg/dm² |
| | (mg/dm²)^{(1,2)} | | | | | [PASS] |
| 3% w/v acetic acid | 3% w/v | 30 days ± | 5° C. ± 1° C. | 10 mg/dm²⁽³⁾ | 10% | 0.5 |
| | acetic acid | 5 h | | | | mg/dm² |
| | (mg/dm²)^{(1,2)} | | | | | [PASS] |
| 10% v/v ethanol | 10% v/v | 10 days ± | Start 40° C. ± | 10 mg/dm²⁽³⁾ | 10% | 0.5 |
| | ethanol | 5 h | 2° C.; ramp | | | mg/dm² |
| | (mg/dm²)^{(1,2)} | | down 24 h; | | | [PASS] |
| | | | 9 days 5° C. ± | | | |
| | | | 1° C. | | | |
| 3% w/v acetic acid | 3% w/v | 30 days ± | Start 40° C. ± | 10 mg/dm²⁽³⁾ | 10% | 0.5 |
| | acetic acid | 5 h | 2° C.; ramp | | | mg/dm² |
| | (mg/dm²)^{(1,2)} | | down 24 h; | | | [PASS] |
| | | | 9 days 5° C. ± | | | |
| | | | 1° C. | | | |

⁽¹⁾DS/EN1186-01: 2002, Guide to selection of conditions and test methods for overall migration,
⁽²⁾DS/EN1186-09: 2002, Test methods for overall migration into aqueous food simulants by filling.
⁽³⁾According to regulation (EC) 10/2011 incl. amendments.

TABLE 6
Migration Properties - PCP and formaldehyde

| | | | Maximum | |
|---|---|---|---|---|
| | Result | | permissible | |
| Test | (unit) | | limit⁽³⁾ | Conclusion |
| Content of | <0.05 | mg/kg | 0.15 | PASS |
| Pentachlorophenol (PCP) | | | | |
| CAS: 87-86-5 ⁽⁴⁾ | | | | |
| Extractable Formaldehyde | <3 | mg/kg | 15 | PASS |
| CAS: 50.00-0 ⁽⁵⁾ | | | | |

⁽³⁾According to regulation (EC) 10/2011 incl. amendments.
⁽⁴⁾ Sample preparation according to EN ISO 15320: 2011. Analysis by GC/ECD.
⁽⁵⁾ Sample preparation according to EN 645: 1993, analysis with reference to EN 1541: 2001.

### EXAMPLE 19: BIODEGRADABILITY TEST

Containers (Example 19A) were prepared according to the third aspect [using material prepared according to Example 5, smooth thermoforming according to Example 11B, and then coated according to Example 12A]. Biodegradability was tested according to EN 13432 (2000) standard “Requirements for packaging recoverable through composting and biodegradation—test scheme and evaluation criteria for the final acceptance of packaging”. The containers were finely divided (<1 mm) in a centrifugal grinder. The dry matter (DM) and total organic carbon content (TOC) were determined, and the corresponding theoretical CO₂ (ThCO₂) determined, which corresponds to the maximal amount of CO₂ that can be converted from the TOC (e.g. ThCO₂=44 g CO₂/12 g TOC). From this the percentage biodegradation can be calculated:

$$\% biodegredation = ( mg {CO}_{2} produced ) / ( {ThCO}_{2} \times mg test substance added ) .$$

TABLE 7
DM and TOC of Example 19A

| | DM | TOC | ThCO₂ |
|---|---|---|---|
| Material | (%) | (%) | (mg CO₂/mg TOC) |
| Example 19A | 100 | 47.7 | 2.14 |
| Sodium benzoate | 99.0 | 58.3 | 1.75 |
| (reference compound) | | | |

The procedure to test biodegradability followed the protocol of OECD 301B—CO₂ Evolution method from OECD Guidelines for the Testing of Chemicals. An inoculum was prepared from activated sludge collected from the aeration tank of a sewage treatment plant (Kallerup Renseanlæg, Taastrup, Denmark). After collection, the activated sludge was filtered through a 400 micron sieve and aerated for 7 days. The solids were concentrated in a centrifuged at 5000 rpm for 10 minutes. After removal of the supernatant, the solids were sampled for dry weight in a dry matter analyser (MJ33, Mettler-Toledo) and mixed with a mineral medium at pH 7.4±0.1 to achieve an dry inoculum concentration of 30 mg/L.

The results are depicted in FIG. 7. FIG. 7 depicts biodegradability (Y-axis, in %) against time (X-axis, in days). The top line (circles) is result of the sodium benzoate reference compound. The next top line (trapezoids) is the result of Example 19A. The remaining lines near the X-axis are polymeric compounds (squares) with poor biodegradability. As can be seen from the graph, containers made according to the third aspect of the invention exhibit good biodegradability.

### EXAMPLE 20: PROPHETIC EXAMPLE ON RECYCLABILITY

Containers (Example 19A) will be prepared according to the third aspect [using material prepared according to Example 5, smooth thermoforming according to Example 11B, and then coated according to Example 12A].

The containers will be assessed for recyclability of packaging products made of paper and board according to the PTS-RH 021:2012 (Draft October 2019)—Category II: Paper and board for Recycling (PfR). PTS stands for Papiertechnische Stiftung.

We anticipate that the containers will possess the following properties:
Disintegratabiliy with a reject content from Brecht-Holl fractionation below >50% (i.e. reasonably usable in paper recycling) [Zellchemig method ZM V/18/62];
No or non-damaging adhesion effect from adhesive impurities from undisturbed sheet formation [screening: Zellchemig method ZM V/1.4/86, Haindl fractionation, sheet formation according to DIN EN ISO 5269];
No or non-disturbing optical inhomogeneities from undisturbed sheet formation [screening: Zellchemig method ZM V/1.4/86, Haindl fractionation, sheet formation according to DIN EN ISO 5269]; and
Overall finding that the material is recyclable.

Without being bound by theory, it is believed that the lower “fibre lift-up” (i.e. smoother surface) obtained by the method according to the first aspect (which is the first part of the process according the third aspect of the invention) allows a better separation of the pulp fibres from layers of other material attached to the pulp fibres. It is believed that loose fibres of the “fibre lift-up” partially penetrate the barrier layer, entraining fibre material irreversibly with the barrier material, lowering the amount of fibres that can be recovered during recycling. It is also believed that loose fibres of the “fibre lift-up” partially penetrate the barrier layer, entraining adhesive material irreversibly with the fibre material isolated during recycling, leading to entrainment of adhesive material that is deleterious during subsequent recycled paper and/or board manufacture. It is also believed that loose fibres of the “fibre lift-up” partially penetrate the barrier layer, entraining barrier material irreversibly with the fibre material isolated during recycling, leading to entrainment of barrier material that is deleterious during subsequent recycled paper and/or board manufacture due to spots of discolouration in the resultant material (entrainment of dyed materials from outermost packaging, for instance). It is consequently believed that materials obtained by the third aspect of the present invention possess advantageous properties with regards to recyclability, which are advantageous properties for use in packaging. Such packaging includes food, cosmetic, home care product, detergent, personal care and pharmaceutical packaging.

1. A process for obtaining a paper material having a high wetted conformal stability, the process comprising the steps of:
a) providing a cellulose-containing parenchymal microparticulate plant material, preferably comprising microparticles having an average particle diameter of from 10 μm to 500 μm as determined by ISO method NO. 20998-3:2017;
b) suspending the cellulose-containing parenchymal microparticulate plant material in a solution, preferably an aqueous solution;
c) mixing the suspension of cellulose-containing parenchymal microparticulate plant material with a suspension of a wood pulp, preferably an aqueous suspension of a kraft pulp;
d) providing one or more linker compounds and one or more esterification catalysts to the mixed suspension, wherein each of the one or more linker compounds comprise two or more carboxylic acid moieties, under conditions that allow the mixture to react at least in part;
e) isolating the solids from the suspension;
optionally, f) drying the isolated solids or the shaped article.

2. The process according to claim 1, further comprising a step (g) of modifying and/or shaping the materials obtained in step (e) and/or step (f).

3. The process according to claim 2, wherein step (g) comprises
(g1) pressing the moulded article;
(g2) heating the pressed article whilst the pressed article is retained on a mould tool, or on another tool onto which the article has been transferred; and/or
preferably, (g3) at least one further treatment step to finish the article and/or to remove additional water from the article.

4. The process according to claim 1, wherein the parenchymal microparticulate plant material comprises less than 20 wt. % lignin.

5. The process according to claim 1, wherein the parenchymal microparticulate plant material has a water absorption capacity (WAC) in the range of from 2 to 10.

6. The process according to claim 5, wherein the parenchymal microparticulate plant material is composed of treated:
i) herbaceous plant material selected from root vegetables including carrot, sugar beet, turnip, parsnip and swede; fruit materials including apples, pears, citrus and grapes; and/or
ii) tubers, including potato; sweet potato, yam, rutabaga and yucca root; preferably sugar beet.

7. A process according to claim 6, wherein the parenchymal microparticulate material is obtained from herbaceous starting material comprising sugar beet (beta vulgaris) materials obtained after the sugar juice extraction step, and/or orange peels or apple residue obtained from pressing of juice; and wherein the herbaceous starting materials are subjected to a) a washing step to remove any non-plant material debris or contaminants and leaves; then b) pressing of the juice, and washing and cutting up into chips having a thickness in the range of from 0.2 to 0.5 cm; and c) extracting sugar or volatiles from the chips, by contacting the chips with an extractant, to obtain an extracted and size reduced particulate parenchymal plant material; and optionally, d) a micro-sizing step for converting the material to a parenchymal microparticulate plant material.

8. The process according to claim 1, wherein the one or more esterification catalysts are selected from salts of sulfuric, phosphoric, nitric, hydrochloric, or acetic acid, preferably wherein the esterification catalyst is sodium hypophosphite.

9. The process according to claim 1, wherein the one or more linker compounds are selected from citric acid, 2,3-Dihydroxybutanedioic acid (tartaric acid), ethanedioic acid, propanedioic acid, butanedioic acid (succinic acid), pentanedioic acid, hexanedioic acid, heptanedioic acid, octanedioic acid, nonanedioic acid, decanedioic acid, undecanedioic acid, dodecanedioic acid, tridecanedioic acid, hexadecanedioic acid, heneicosadioic acid, docosanedioic acid, triacontanedioic acid, (Z)-butenedioic acid, (E)-butenedioic acid, but-2-ynedioic acid, (Z)-pent-2-enedioic acid, (E)-pent-2-enedioic acid, 2-decenedioic acid, dodec-2-enedioic acid, (2E,4E)-hexa-2,4-dienedioic acid, (2Z,4E)-hexa-2,4-dienedioic acid, (2Z,4Z)-hexa-2,4-dienedioic acid, (RS)-penta-2,3-dienedioic acid, (2Z)-2-methylbut-2-enedioic acid, (2E)-2-methyl-2-butenedioic acid, 2-methylidene-butanedioic acid, 2-Hydroxypropanedioic acid, oxopropanedioic acid, hydroxybutanedioic acid, 2,3-dihydroxybutanedioic acid, oxobutanedioic acid, 2-aminobutanedioic acid, dioxobutanedioic acid, 2-hydroxypentanedioic acid, 2,3,4-trihydroxypentanedioic acid, 3-oxopentanedioic acid, 2-oxo-pentanedioic acid, 2-aminopentanedioic acid, (2R,6S)-2,6-diaminoheptanedioic acid, (2S,3S,4S,5R)-2,3,4,5-tetrahydroxyhexanedioic acid or any metal salt or any anhydride thereof, preferably selected from selected from citric acid, 2,3-Dihydroxybutanedioic acid (tartaric acid), ethanedioic acid, propanedioic acid, butanedioic acid (succinic acid), pentanedioic acid, hexanedioic acid, heptane-dioic acid, octanedioic acid, nonanedioic acid, decanedioic acid, undecanedioic acid, dodecanedioic acid, tridecanedioic acid, hexadecanedioic acid, heneicosadioic acid, docosanedioic acid, triacontanedioic acid, (Z)-butenedioic acid, (E)-butenedioic acid, but-2-ynedioic acid, (Z)-pent-2-enedioic acid, (E)-pent-2-enedioic acid, 2-decenedioic acid, dodec-2-enedioic acid, (2E,4E)-hexa-2,4-dienedioic acid, (2Z,4E)-hexa-2,4-dienedioic acid, (2Z,4Z)-hexa-2,4-dienedioic acid, (RS)-penta-2,3-dienedioic acid, (2Z)-2-methylbut-2-enedioic acid, (2E)-2-methyl-2-butenedioic acid, 2-methylidenebutanedioic acid, 2-Hydroxypropanedioic acid, oxopropanedioic acid, hydroxybutanedioic acid, 2,3-dihydroxybutanedioic acid, oxobutanedioic acid, 2-aminobutanedioic acid, dioxobutanedioic acid, 2-hydroxypentanedioic acid, 2,3,4-trihydroxypentanedioic acid, 3-oxopentanedioic acid, 2-oxopentanedioic acid, 2-aminopentanedioic acid, (2R,6S)-2,6-diaminoheptanedioic acid, (2S,3S,4S,5R)-2,3,4,5-tetrahydroxyhexanedioic acid, benzene-1,2-dicarboxylic acid, benzene-1,3-dicarboxylic acid, benzene-1,4-dicarboxylic acid, 2-(2-carboxyphenyl) benzoic acid, 2,6-naphthalenedicarboxylic acid or any sodium salt thereof, more preferably the one or more linker compounds are selected from citric acid or sodium citrate, most preferably the linker compound is citric acid.

10. A material obtainable by the process according to claim 1, comprising a cross-linked composition comprising a pulp and parenchymal microparticulate plant material, and having an ultimate tensile strength of greater than 11 MPa, and being fully biodegradable when comprised of 95 to 96 wt. % of cellulose.

11. The material according to claim 10, having:
a) an Oxygen Transmission Rate (OTR) value in the range of 0.01 to 4.0 cc/m2/24 h (23° C., 50% relative humidity) according to D3985-17 at a grammage between 1 and 20 gsm, preferably having an OTR value in the range of 0.01-1.0 cc/m2/24 h (23° C., 50% RH) according to D3985-17 at a grammage between 1.5 and 15 gsm, most preferably has an OTR value in the range of 0.02-0.80 cc/m2/24 h (23° C., 50% RH) according D3985-17 at a grammage between 2 and 5 gsm; and/or
b) a wear index of less than 450 mg/1000 revolutions as determined by abrasive wear test ISO 9352:2012, preferable of less than 400 mg/1000 revolutions, more preferably of less than 375 mg/1000 revolutions, even more preferably of less than 350 mg/1000 revolutions, yet more preferably of less than 325 mg/1000 revolutions and most preferably of less than 300 mg/1000 revolutions.

12. The material according to claim 10, wherein the material is shaped into, or comprised in a packaging item, preferably wherein the material is shaped into, or comprised in a container for storage, dispensing, packaging, wrapping or transport, preferably comprising of containers for food and other articles, comprising bags, barrels, bottles, boxes, cans, cartons, crates, drums, jars, tanks, hoppers, accessories, closures, fittings or lids.

13. (canceled)

14. The process according to claim 1, further comprising the steps of
h) contacting at least part of the surface of the material obtained in steps (e) or (f) with a coating composition comprising a binder composition comprising one or more water borne polymers and parenchymal microparticulate plant material comprising microparticles having an average particle diameter of from 10 μm to 500 μm; and
j) drying the coated object, to provide an object comprising a polymeric water and fat resistant coating.

15. The process according to claim 14, wherein the binder composition comprises a modified starch and/or a polyvinyl alcohol, preferably a hydroxypropylated starch component and/or a polyvinyl alcohol component.

16. A material obtainable by the process according to claim 14, wherein:
a) the surface treated object has a Water Vapor Transmission Rate (WVTR) value in the range of 0.25 to 4.0 cc/m2/24 h (23° C., 50% relative humidity) according to ASTM F-1249-06 at a grammage between 1 and 20 gsm, preferably has a WVTR value in the range of 0.5-2.0 cc/m2/24 h (23° C., 50% RH) according to ASTM F-1249-06 at a grammage between 1.5 and 15 gsm, most preferably has a WVTR value in the range of 1-1.5 cc/m2/24 h (23° C., 50% RH) according to ASTM F-1249-06 at a grammage between 2 and 5 gsmU;
b) the surface treated object has a Water Vapor Transmission Rate (WVTR) value in the range of 0.25 to 4.0 cc/m2/24 h (23° C., 50% relative humidity) according to ISO/IEC 17025:2017 at a coating weight grammage between 1 and 20 gsm, preferably has a WVTR value in the range of 0.5-2.0 cc/m2/24 h (23° C., 50% RH) according to ISO/IEC 17025:2017 at a coating weight grammage between 1.5 and 15 gsm, most preferably has a WVTR value in the range of 1-1.5 cc/m2/24 h (23° C., 50% RH) according to ISO/IEC 17025:2017 at a coating weight grammage between 2 and 5 gsm;
c) the material has an Oxygen Transmission Rate (OTR) value in the range of 0.01 to 4.0cc/m2/24 h (23° C., 50% relative humidity) according to D3985-17 at a coating weight grammage between 1 and 20 gsm, preferably having an OTR value in the range of 0.01-1.0 cc/m2/24 h (23° C., 50% RH) according to D3985-17 at a coating weight grammage between 1.5 and 15 gsm, most preferably has a WVTR value in the range of 0.02-0.80 cc/m2/24 h (23° C., 50% RH) according D3985-17 at a coating weight grammage between 2 and 5 gsm; and/or
d) the material is recyclable according to PTS-RH 021:2012 (Draft October 2019)—Category II: Paper and board for Recycling (PfR).

17-19. (canceled)

20. A method of enhancing the tear strength, water resistance, or Water Vapor Transmission Rate (WVTR) of a paper pulp or paper pulp article material, the method comprising contacting the paper pulp with a cellulose-containing parenchymal microparticulate material, optionally comprising microparticles having an average particle diameter of from 10 μm to 500 μm, when crosslinked with a linker, used in a coating composition, and/or to enhance the biodegradability thereof.

21. (canceled)

22. A recyclable packaging material obtained by the method of claim 1.

23. (canceled)

24. The recyclable packaging material according to claim 22, wherein the recyclable packaging material:
a) is selected from food, cosmetic, home care product, detergent, personal care and pharmaceutical packaging;
b) is selected from primary, secondary or tertiary packaging;
c) comprises a heat seal;
d) has been hot-pressed or thermoformed; and/or
e) is a heat-sealable pouch or a heat sealed pouch.

25-28. (canceled)

29. The recyclable packaging material according to claim 22, wherein the recyclable packaging material is:
a) a heat sealable tray or a heat sealed tray, preferably a heat sealable tray suitable for microwaving the contents or a heat sealed microwave food tray, more preferably a heat sealable tray suitable for microwaving the high water activity meals or a heat sealed microwave food tray comprising a high water activity meal; or
b) a multilayer packaging material, preferably a multilayer packaging material selected from a multiwall paper sack, a laminated carton, a bottle or a tetra brik aseptic carton package, more preferably the recyclable packaging material is a tetra brik aseptic carton package.

30-31. (canceled)

32. A barrier coating for a paperboard substrate comprising:
(i) a water borne polymer selected from the group of acrylate polymers, a co-polymer prepared from (i) acrylate monomers and
(ii) at least one non-acrylate monomer starting material, water-dispersible polyurethanes, styrene acrylics, polyvinyl alcohol, a copolymer of ethylene and polyvinyl alcohol, starch, carboxymethylcellulose and combinations thereof in an amount of at least 50 weight %, based on the dry weight of the barrier coating; and
(ii) a parenchymal microparticulate plant material obtained by the method of claim 6.
